(19) United States
(12) Patent Application Publication
(10) Pub. No.: US 2026/0234420 A1
(43) Pub. Date: Aug. 13, 2026

(54) CARBON MATERIAL DISPERSION AND USE THEREOF

(71) Applicant: DAINICHISEIKA COLOR & CHEMICALS MFG. CO., LTD., Tokyo (JP)

(72) Inventors: Seiji DOI, Tokyo (JP); Risa SHITAOKA, Tokyo (JP); Kozaburo HAYASHI, Tokyo (JP); Yuzuru SATO, Tokyo (JP); Hiroya ONIDUKA, Tokyo (JP); Daichi UMEDA, Tokyo (JP); Shota KANEKO, Tokyo (JP); Hiroyuki SHIMANAKA, Tokyo (JP); Yoshikazu MURAKAMI, Tokyo (JP)

(21) Appl. No.: 18/879,122

(22) PCT Filed: Mar. 22, 2023
(86) PCT No.: PCT/JP2023/011092

§ 371 Date: Sep. 29, 2025

(30) Foreign Application Priority Data
Jul. 29, 2022 (JP) 2022-121683
Sep. 20, 2022 (JP) 2022-149296

(51) Int. Cl. C09D 5/24; C09D 7/45; C09D 7/61; C09D 7/65; C09D 101/28; C09D 125/14

(52) U.S. Cl. CPC C09D 5/24; C09D 7/45; C09D 7/61; C09D 7/65; C09D 101/286; C09D 125/14

(57) ABSTRACT

There is provided a carbon material dispersion capable of forming film having improved electrical conductivity as compared to when a single carbon material is used. The carbon material dispersion contains: at least two carbon materials selected from the group consisting of single-walled carbon nanotubes, multi-walled carbon nanotubes, and carbon black; an aqueous medium; a dispersant; and a binder resin, wherein when the carbon materials are composed of a combination of a single-walled carbon nanotube and carbon black, the amount of carbon black to 1 part by mass of the single-walled carbon nanotube is 0.001 to 0.43 parts by mass, or when the carbon materials are composed of a combination of a single-walled carbon nanotube, a multi-walled carbon nanotube, and carbon black, the amount of carbon black based on 1 part by mass of the total amount of the single-walled carbon nanotube and the multi-walled carbon nanotube is 0.001 to 0.43 parts by mass.

### TECHNICAL FIELD

The present invention relates to a carbon material dispersion and use thereof.

### BACKGROUND ART

Carbon materials (nanocarbon materials) such as carbon black, a carbon fiber, a carbon nanotube (hereinafter, also referred to as “CNT”), graphite, and graphene have a six-membered cyclic graphite structure formed by covalent bonds of carbon atoms. Therefore, the carbon materials exhibit various properties such as electrical conductivity and heat transfer properties, and methods for utilizing the properties have been studied in a wide range of fields. For example, taking notice of the electrical characteristics, thermal characteristics, and characteristics as a filler of carbon materials, use of carbon materials for antistatic agents, electrically conductive materials, plastic reinforcing materials, semiconductors, electrodes of fuel cells, secondary batteries, and the like, and cathode rays for displays has been studied.

In recent years, there has been a demand for higher performance in these applications, and CNTs are being used widely as the carbon materials. Note that to improve various properties such as electrical conductivity, not only the type and amount of a dispersant for dispersing CNT in a liquid medium but also selection of a binder resin which is used when a coating film, an electrode, or the like is formed is important.

For example, there are disclosed, as related conventional techniques, a resin composition containing: CNT synthesized using a particular catalyst; and a resin, and a method for evaluating the electrical conductivity of the CNT by measuring the surface resistance of a coating film containing the synthesized CNT (Patent Literature 1). In addition, there are disclosed a CNT dispersion containing single-walled CNT, multi-walled CNT, a dispersant, and a solvent, and a nonaqueous electrolyte secondary battery using this CNT dispersion (Patent Literature 2).

Moreover, there are disclosed a CNT dispersion containing: CNT having an acidic group; a dispersant; and water, wherein the dispersant is a copolymer containing a constituent unit derived from (meth)acrylonitrile and a carboxy group-containing monomer unit, and an electrode film for a secondary battery, obtained by using this CNT dispersion (Patent Literature 3). Furthermore, there are disclosed an aqueous CNT dispersion containing single-walled CNT, acetylene black, a dispersant, and water, wherein the mass ratio of acetylene black/single-walled CNT is 1.4 or less, and an electrically conductive film for a solar cell, obtained using this aqueous CNT dispersion (Patent Literature 4).

### CITATION LIST

### Patent Literature

Patent Literature 1: Japanese Patent Laid-Open No. 2015-123410
Patent Literature 2: Japanese Patent Laid-Open No. 2022-079409
Patent Literature 3: Japanese Patent Laid-Open No. 2021-190331
Patent Literature 4: International Publication No. WO 2022/064939

### SUMMARY OF INVENTION

### Technical Problem

Carbon material dispersions containing a carbon material such as CNT are used as, for example, materials for improving the electrical conductivity of target articles and the like. The electrical conductivity of a carbon material dispersion can be evaluated by, for example, measuring the surface resistivity of a coating film formed by applying and drying the carbon material dispersion.

The present inventors have formed films using conventional CNT dispersions and the like disclosed in Patent Literatures 2 to 4 and the like and evaluated the electrical conductivity by measuring the surface resistivity for the formed coating films. As a result, it has become clear that any of the coating films formed using the CNT dispersions and the like does not exhibit electrical conductivity at a high level that has been required in recent years.

The present invention has been completed in view of such a problem of the conventional techniques, and an object of the present invention is to provide a carbon material dispersion capable of forming a coating film having improved electrical conductivity compared to when a single carbon material is used. Another object of the present invention is to provide use of the carbon material dispersion for producing various products and for producing a film which is a constituent member for various products.

### Solution to Problem

Specifically, according to the present invention, there is provided a carbon material dispersion described below.

[1] A carbon material dispersion containing:
at least two carbon materials selected from the group consisting of single-walled carbon nanotubes, multi-walled carbon nanotubes, and carbon black;
an aqueous medium;
a dispersant; and
a binder resin, wherein
the carbon material dispersion satisfies the following requirements (1) and (2):
   (1) when the carbon materials are composed of a combination of a single-walled carbon nanotube and carbon black, the amount of carbon black based on 1 part by mass of the single-walled carbon nanotube is 0.001 to 0.43 parts by mass,
when the carbon materials are composed of a combination of a multi-walled carbon nanotube and carbon black, the amount of carbon black based on 1 part by mass of the multi-walled carbon nanotube is 0.001 to 0.43 parts by mass,
when the carbon materials are composed of a combination of a single-walled carbon nanotube and a multi-walled carbon nanotube, the amount of the multi-walled carbon nanotube based on 1 part by mass of the single-walled carbon nanotube is 10 to 100 parts by mass, or
when the carbon materials are composed of a combination of a single-walled carbon nanotube, a multi-walled carbon nanotube, and carbon black, the amount of carbon black based on 1 part by mass of the total amount of the single-walled carbon nanotube and the multi-walled carbon nanotube is 0.001 to 0.43 parts by mass, and the amount of the multi-walled carbon nanotube based on 1 part by mass of the single-walled carbon nanotube is 10 to 100 parts by mass;
   (2) the surface resistivity of a dry film containing 3% by mass of the carbon materials and having a thickness of 1 μm is 1.0×10⁶ Ω/sq or less.

[2] The carbon material dispersion according to [1], wherein
the dispersant is at least any one of a polymeric dispersant and a cellulose derivative, and
the polymeric dispersant is a polymer having a constituent unit (1) derived from (meth)acrylonitrile and a constituent unit (2) derived from (meth)acrylic acid.

[3] The carbon material dispersion according to [2], wherein the polymeric dispersant is a polymer having carboxy groups at least part of which are neutralized with an alkali, the polymer having 50 to 80% by mass of the constituent unit (1) and 20 to 50% by mass of the constituent unit (2), provided that the total amount of the constituent unit (1) and the constituent unit (2) is 100% by mass.

[4] The carbon material dispersion according to [3], wherein
the polymer is an A-B block copolymer containing:
a polymer block A having 60 to 95% by mass of a constituent unit (1-A) derived from acrylonitrile and 5 to 40% by mass of a constituent unit (2-A) derived from methacrylic acid, provided that the total amount of the constituent unit (1-A) and the constituent unit (2-A) is 100% by mass; and
a polymer block B having 10 to 70% by mass of a constituent unit (1-B) derived from acrylonitrile and 30 to 90% by mass of a constituent unit (2-B) derived from methacrylic acid, provided that the total amount of the constituent unit (1-B) and the constituent unit (2-B) is 100% by mass,
the polymer block A has a number average molecular weight of 10,000 to 100,000 and a polydispersity index of 1.8 or less, and
the polymer block B has a number average molecular weight of 3,000 to 200,000.

[5] The carbon material dispersion according to any one of [1] to [4], wherein the binder resin is at least one selected from the group consisting of cellulose derivatives, styrene-butadiene copolymers, and acrylic resins.

[6] The carbon material dispersion according to any one of [1] to [5], wherein
when the carbon materials contain a single-walled carbon nanotube, the amount of the dispersant based on 100 parts by mass of the single-walled carbon nanotube is 30 to 200 parts by mass,
when the carbon materials contain a multi-walled carbon nanotube, the amount of the dispersant based on 100 parts by mass of the multi-walled carbon nanotube is 30 to 200 parts by mass, and
when the carbon materials contain carbon black, the amount of the dispersant based on 100 parts by mass of carbon black is 10 to 200 parts by mass.

[7] The carbon material dispersion according to any one of [1] to [6], wherein
surface resistivity a (Ω/sq) of a first film formed by applying and drying the carbon material dispersion, the first film containing 3% by mass of the carbon materials and having a thickness of 1 μm and surface resistivity b (Ω/sq) of a second film formed by applying and drying a control dispersion having the same composition as the carbon material dispersion except that one of the carbon materials is not contained, the second film containing 3% by mass of the carbon material or carbon materials and having a thickness of 1 μm satisfy a relationship of a<b, and
the surface resistivity a is 5.0×10⁵ Ω/sq or less.

[8] The carbon material dispersion according to any one of [1] to [7], wherein
the single-walled carbon nanotubes have an average length of 5 to 600 μm, and
the multi-walled carbon nanotubes have an average length of 40 to 3,000 μm.

[9] The carbon material dispersion according to any one of [1] to [8], obtained by mixing
a first dispersion containing at least one of the carbon materials and
a second dispersion containing at least one of the carbon materials, different from the carbon material in the first dispersion.

[10] The carbon material dispersion according to any one of [1] to [9], wherein when a dilute dispersion is obtained by diluting the carbon material dispersion with a blank solution having the same composition as the carbon material dispersion except that the carbon materials and the binder resin are not contained in such a way that absorbance at a wavelength of 580 nm is 1.8±0.02, a ratio (A_{L}/A_{H}) of absorbance A_{L} at a wavelength of 380 nm to absorbance A_{H} at a wavelength of 780 nm is 1.40 or more for the dilute dispersion.

Furthermore, according to the present invention, there is provided use of a carbon material dispersion described below.

[11] Use of the carbon material dispersion according to any one of [1] to [10] for producing any one of the products of paints, inks, coating agents, materials for resin shaped articles, electrically conductive materials, thermally conductive materials, and antistatic agents.

[12] Use of the carbon material dispersion according to any one of [1] to [10] for producing any one of the products of battery materials and mechanical components each including a film formed with the carbon material dispersion.

### Advantageous Effects of Invention

The present invention makes it possible to provide a carbon material dispersion capable of forming a coating film having more improved electrical conductivity as compared to when a single carbon material is used. Furthermore, the present invention makes it possible to provide use of the carbon material dispersion for producing various products and for producing a film which is a constituent member for various products.

### DESCRIPTION OF EMBODIMENTS

### <Carbon Material Dispersion>

Hereinafter, embodiments of the present invention will be described, but the present invention is not limited to the following embodiments. One embodiment of a carbon material dispersion of the present invention contains: at least two carbon materials selected from the group consisting of single-walled carbon nanotubes, multi-walled carbon nanotubes, and carbon black; an aqueous medium; a dispersant; and a binder resin. The carbon material dispersion of the present embodiment satisfies the following requirements (1) and (2). Hereinafter, the carbon material dispersion (hereinafter, simply referred to as “dispersion”) of the present invention will be described in detail.

(1) When the carbon materials are composed of a combination of a single-walled carbon nanotube and carbon black, the amount of carbon black based on 1 part by mass of the single-walled carbon nanotube is 0.001 to 0.43 parts by mass,
when the carbon materials are composed of a combination of a multi-walled carbon nanotube and carbon black, the amount of carbon black based on 1 part by mass of the multi-walled carbon nanotube is 0.001 to 0.43 parts by mass,
when the carbon materials are composed of a combination of a single-walled carbon nanotube and a multi-walled carbon nanotube, the amount of the multi-walled carbon nanotube based on 1 part by mass of the single-walled carbon nanotube is 10 to 100 parts by mass, or
when the carbon materials are composed of a combination of a single-walled carbon nanotube, a multi-walled carbon nanotube, and carbon black, the amount of carbon black based on 1 part by mass of the total amount of the single-walled carbon nanotube and the multi-walled carbon nanotube is 0.001 to 0.43 parts by mass, and the amount of the multi-walled carbon nanotube based on 1 part by mass of the single-walled carbon nanotube is 10 to 100 parts by mass.
   (2) The surface resistivity of a dry film containing 3% by mass of the carbon materials and having a thickness of 1 μm is 1.0×10⁶ Ω/sq or less.

### (Carbon Materials)

The carbon materials are at least two selected from the group consisting of single-walled carbon nanotubes, multi-walled carbon nanotubes, and carbon black. The single-walled carbon nanotubes (hereinafter, also referred to as “SWCNT(s)”) preferably have an average length of 5 to 600 μm, more preferably 10 to 500 μm. The multi-walled carbon nanotubes (hereinafter, also referred to as “MWCNT(s)”) preferably have an average length of 40 to 3,000 μm. When the dispersion of the present embodiment is used as a constituent material of a battery, MWCNTs preferably have an average length of 100 to 3,000 μm because the surface resistivity of a coating film to be formed can be lowered more.

Examples of carbon black (hereinafter, also referred to as “CB”) include acetylene black, furnace black, thermal black, and Ketjen black. CB preferably has an average primary particle size of 10 to 60 nm. A metal, such as platinum and palladium, or a metal salt may be doped in the carbon materials. In addition, the carbon materials may be surface-modified by oxidation treatment, plasma treatment, radiation treatment, corona treatment, coupling treatment, or the like.

As an electrically conductive carbon material from for forming an electrode, SWCNT is suitable the viewpoint of cycle characteristics. However, is SWCNT likely to form aggregates during formation of a coating film, and therefore the coating film to be formed tends to have the same or higher resistance as compared to when MWCNT is used. On the other hand, MWCNT is easily dispersed and is therefore unlikely to form aggregates, so that the resistance of a coating film to be formed can be lowered, but MWCNT tends to be inferior to SWCNT in terms of cycle characteristics. For this reason, the use of SWCNT and MWCNT together in a predetermined ratio makes it possible to prepare a dispersion capable of forming a coating film for an electrode having excellent electrical conductivity and cycle characteristics.

When at least one of SWCNT and MWCNT, and CB are used together in a predetermined ratio, CB is disposed such that the voids in a network formed of fiber-shaped CNT are filled in a coating film to be formed. This increases the number of electrically conductive paths, which therefore makes it possible to form a coating film having a lower surface resistivity as compared to when CNT is used singly although the content of the carbon materials is the same.

Note that even if CB is not used, the surface resistivity of a coating film to be formed can be lowered by increasing the content of CNT. However, when the content of CNT in the coating film is increased, the content of the binder resin which is suitably used as a material for forming a coating film is relatively decreased, and therefore the properties such as stretching and bending of the binder resin are unlikely to be reflected. In contrast, when at least one of SWCNT and MWCNT, and CB are used together in a predetermined ratio in the dispersion of the present embodiment, thereby it is possible to form, without excessively using CNT, a coating film in which properties such as stretching and bending of the binder resin are likely to be reflected.

The dispersion of the present embodiment satisfies the following requirement (1). When the following requirement (1) is satisfied, specifically when at least two carbon materials are contained in a particular ratio, thereby a coating film having improved electrical conductivity as compared to when a single carbon material is contained can be formed.

(1)

(1-1) When the carbon materials are composed of a combination of SWCNT and CB, the amount of CB based on 1 part by mass of SWCNT is 0.001 to 0.43 parts by mass, preferably 0.01 to 0.3 parts by mass.

(1-2) When the carbon materials are composed of a combination of MWCNT and CB, the amount of CB based on 1 part by mass of MWCNT is 0.001 to 0.43 parts by mass, preferably 0.01 to 0.3 parts by mass.

(1-3) When the carbon materials are composed of a combination of SWCNT and MWCNT, the amount of MWCNT based on 1 part by mass of SWCNT is 10 to 100 parts by mass, preferably 20 to 80 parts by mass.

(1-4) When the carbon materials are composed of a combination of SWCNT, MWCNT, and CB, the amount of CB based on 1 part by mass of the total amount of SWCNT and MWCNT is 0.001 to 0.43 parts by mass, preferably 0.01 to 0.3 parts by mass, and the amount of MWCNT based on 1 part by mass of SWCNT is 10 to 100 parts by mass, preferably 20 to 80 parts by mass.

Furthermore, the carbon material dispersion of the present embodiment satisfies the following requirement (2). In other words, when the carbon material dispersion of the present embodiment satisfies the above requirement (1), thereby a coating film satisfying the following requirement (2), the coating film having improved electrical conductivity, can be formed.

(2) the surface resistivity of a dry film containing 3% by mass of the carbon materials and having a thickness of 1 μm is 1.0×10⁶ Ω/sq or less, preferably 5.0×10⁵ Ω/sq or less.

As described above, the use of the carbon material dispersion of the present embodiment makes it possible to form a coating film having improved electrical conductivity as compared to when a dispersion containing a single carbon material is used. Specifically, surface resistivity a (Ω/sq) of a first film formed by applying and drying the carbon material dispersion (dispersion a), the first film containing 3% by mass of the carbon materials and having a thickness of 1 μm and surface resistivity b (Ω/sq) of a second film formed by applying and drying a control dispersion (dispersion b) having the same composition as the carbon material dispersion (dispersion a) except that one of the carbon materials is not contained, the second film containing 3% by mass of the carbon material or carbon materials and having a thickness of 1 μm preferably, satisfy a relationship of a<b. In addition, the surface resistivity a is preferably 5.0×10⁵ (Ω/sq) or less.

The dispersion of the present embodiment may further contain an additional carbon material other than the above-described carbon materials. As the additional carbon material, a carbon fiber, graphite, graphene, and the like can be used.

Examples of the carbon fiber include PAN-based carbon fibers using polyacrylonitrile as a raw material, pitch-based carbon fibers using pitch or the like, and recycled products thereof. Among others, the carbon fiber is preferably a carbon nanofiber having a nanosized fiber diameter and having a cylindrical shape obtained by winding six-membered cyclic graphite structures. Graphite is a layered substance containing hexagonal plate-like crystals composed of carbon. Among others, graphene formed of a single layer having a thickness of one atom, obtained by peeling of graphite, and graphene formed of multi layers can be used.

In the additional carbon material, a metal, such as platinum and palladium, or a metal salt may be doped. In addition, the additional carbon material may be surface-modified by oxidation treatment, plasma treatment, radiation treatment, corona treatment, coupling treatment, or the like.

### (Aqueous Medium)

The carbon material dispersion of the present embodiment contains an aqueous medium which is a liquid medium for dispersing the carbon materials. Specifically, the dispersion of the present embodiment is an aqueous dispersion of the carbon materials.

As the aqueous medium, water or a mixed solvent of water and a water-soluble organic solvent can be used. Examples of the water-soluble organic solvent include: alcohols, such as methanol, ethanol, and isopropyl alcohol; polyhydric alcohols, such as ethylene glycol, propylene glycol, and glycerol; ethers, such as tetrahydrofuran; glycol ethers, such as diethylene glycol, triethylene glycol, diethylene glycol monomethyl ether, diethylene glycol monobutyl ether, ethylene glycol dimethyl ether, propylene glycol monomethyl ether, propylene glycol monoethyl ether, propylene glycol monopropyl ether, dipropylene glycol monomethyl ether, and tripropylene glycol monomethyl ether; glycol ether esters, such as diethylene glycol monomethyl ether acetate; amides, such as pyrrolidone, N-methylpyrrolidone, dimethylformamide, dimethylacetamide, 3-methoxy-N, N-dimethylpropanamide, and 3-butoxy-N, N-dimethylpropanamide; urea-based solvents, such as tetramethyl urea and 1,3-dimethylimidazolidinone; sulfur-containing solvents, such as dimethyl sulfoxide and sulfolane; and ionic liquids, such as 1-ethyl-3-methyl imidazolium chloride. Among others, the water-soluble organic solvent is preferably an alcohol or N-methylpyrrolidone (NMP).

The content of the water-soluble organic solvent in the carbon material dispersion is preferably set to 20% by mass or less, more preferably 10% by mass or less.

### (Dispersant)

The dispersant is a constituent for dispersing the carbon materials in a liquid medium. As the dispersant, anionic, cationic, nonionic, and amphoteric surfactants, and polymeric dispersants can be used. Among others, at least one of a polymeric dispersant and a cellulose derivative is preferably used as the dispersant.

Examples of the cellulose derivative include methyl cellulose, carboxymethyl cellulose, hydroxyethyl cellulose, hydroxypropylmethyl cellulose, and metal salts thereof. Among others, the cellulose derivative is preferably carboxymethyl cellulose or carboxymethyl cellulose sodium salt. Furthermore, the cellulose derivative preferably gives a viscosity of a 1%-by-mass aqueous solution of 20 to 500 mPa·s and has a degree of etherification of 0.5 to 0.9. The use of such a cellulose derivative makes it possible to better disperse the carbon materials and improve the storage stability.

The polymeric dispersant is preferably a polymer having a constituent unit (1) derived from (meth)acrylonitrile and a constituent unit (2) derived from (meth)acrylic acid. The polymeric dispersant is preferably a polymer substantially consisting of the constituent unit (1) derived from (meth)acrylonitrile and the constituent unit (2) derived from (meth)acrylic acid. In addition, the polymeric dispersant is preferably a polymer having carboxy groups at least part of which are neutralized with an alkali.

The constituent unit (1) has a cyano group (—CN) derived from (meth)acrylonitrile. For this reason, the triple bond of the cyano group acts on the surfaces of the carbon materials, so that the polymer which is a dispersant is electrically adsorbed onto the carbon materials. The constituent unit (2) has a carboxy group derived from (meth)acrylic acid. For this reason, the polymer which is a dispersant can be dissolved in the aqueous medium by neutralizing and ionizing at least part of the carboxy groups with an alkali. The use of the polymer containing these constituent unit (1) and constituent unit (2) as a dispersant makes it possible to disperse the carbon materials finely in the aqueous medium over a long period of time.

The proportion of the constituent unit (1) derived from (meth)acrylonitrile in the polymer is 50 to 80% by mass, preferably 55 to 75% by mass. The proportion of the constituent unit (2) derived from (meth)acrylic acid in the polymer is 20 to 50% by mass, preferably 25 to 45% by mass. Note that the total amount of the constituent unit (1) and the constituent unit (2) is 100% by mass. When the proportion of the constituent unit (2) in the polymer is less than 20% by mass, the water-solubility of the polymer is deficient. On the other hand, when the proportion of the constituent unit (2) in the polymer is more than 50% by mass, the water-solubility of the polymer is excessively high. This makes the viscosity of the carbon material dispersion excessively high and may lower the water resistance of a coating film to be formed because the amount of the hydrophilic carboxy groups is large.

The polymeric dispersant (polymer) may further additional constituent unit other than have an the constituent unit (1) and the constituent unit (2). Examples of monomers for forming the additional constituent unit include conventionally known styrene-based monomers and (meth)acrylate-based monomers. Among others, a monomer free of an easily hydrolyzable structure, such as an ester bond and an amide bond, is preferably used. Examples of such a monomer include styrene, vinylnaphthalene, vinyltoluene, vinylbiphenyl, and vinyl alcohol.

The polymer which is used as the polymeric dispersant may be any of a random copolymer and a block copolymer. However, in a random copolymer, hydrophilic groups and hydrophobic groups are present randomly, and therefore the effect as a dispersant may be somewhat lowered. In addition, when a highly hydrophilic binder resin is further used, the random copolymer may be subjected to an influence of the binder resin more remarkably. For this reason, the polymer which is used as a polymeric dispersant is preferably a block copolymer.

The polymer which is a polymeric dispersant is preferably an A-B block copolymer containing: a polymer block A having a constituent unit (1-A) derived from acrylonitrile and a constituent unit (2-A) derived from methacrylic acid; and a polymer block B having a constituent unit (1-B) derived from acrylonitrile and a constituent unit (2-B) derived from methacrylic acid. Note that the polymer block A is preferably a polymer block substantially consisting of the constituent unit (1-A) derived from acrylonitrile and the constituent unit (2-A) derived from methacrylic acid. In addition, the polymer block B is preferably a polymer block substantially consisting of the constituent unit (1-B) derived from acrylonitrile and the constituent unit (2-B) derived from methacrylic acid.

The proportion of the constituent unit (1-A) derived from acrylonitrile in the polymer block A (hereinafter, also referred to as “chain A”) is preferably 60 to 95% by mass, more preferably 65 to 90% by mass. The proportion of the constituent unit (2-A) derived from methacrylic acid in the chain A is preferably 5 to 40% by mass, more preferably 10 to 35% by mass. Note that the total amount of the constituent unit (1-A) and the constituent unit (2-A) is 100% by mass.

The content of the carboxy groups is smaller in the chain A than in the polymer block B (hereinafter, also referred to as “chain B”), and therefore the chain A is a polymer block having relatively lower water-solubility than the chain B. For this reason, the chain A adsorbed onto the carbon materials is more unlikely to be desorbed than the chain B and therefore has a function of improving the dispersibility of the carbon materials more. When the proportion of the constituent unit (2-A) in the chain A is less than 5% by mass, the water-solubility of the chain A may be deficient. On the other hand, when the proportion of the constituent unit (2-A) in the chain A is more than 40% by mass, the water-solubility of the chain A may be too high and therefore may be more likely to be desorbed from the carbon materials.

The number average molecular weight of the polymer block A (chain A) is preferably 10,000 to 100,000, more preferably 20,000 to 90,000. When the number average molecular weight of the chain A is lower than 10,000, the adsorption onto the carbon materials may be deficient. On the other hand, when the number average molecular weight of the chain A is higher than 100,000, the water-solubility may be insufficient even if the chain A has the constituent unit (2-A) having a carboxy group.

The polydispersity index (PDI=weight average molecular weight (Mw)/number average molecular weight (Mn)) of the polymer block A (chain A) is preferably 1.8 or less, more preferably 1.6 or less. When the molecular weights are relatively uniform, thereby the polymer block A can be adsorbed onto the carbon materials more uniformly, and the dispersibility can be improved further. When the polydispersity index (PDI value) of the chain A is more than 1.8, a large amount of polymer blocks having a number average molecular weight out of the above-described range are contained, so that the effect of improving the dispersibility may be lowered.

The proportion of the constituent unit (1-B) derived from acrylonitrile in the polymer block B (chain B) is preferably 10 to 70% by mass, more preferably 15 to 65% by mass. The proportion of the constituent unit (2-B) derived from methacrylic acid in the chain B is preferably 30 to 90% by mass, more preferably 35 to 85% by mass. Note that the total amount of the constituent unit (1-B) and the constituent unit (2-B) is 100% by mass. The number average molecular weight of the chain B is preferably 3,000 to 200,000, more preferably 5,000 to 60,000. When the number average molecular weight of the chain B is lower than 3,000, the chain B tends to be difficult to dissolve in water. On the other hand, when the number average molecular weight of the chain B is higher than 200,000, there is a tendency that the viscosity increases excessively, which makes it difficult to disperse the carbon materials.

The chain B is a polymer block containing a larger amount of carboxy groups than the chain A and having relatively higher water-solubility than the chain A. When the proportion of the constituent unit (2-B) in the chain B is less than 30% by mass, the water-solubility of the A-B block copolymer as a whole may be deficient. On the other hand, when the proportion of the constituent unit (2-B) in the chain B is more than 90% by mass, the affinity to water may be excessively high. For this reason, the viscosity of the carbon material dispersion may be excessively high, and the water resistance of a coating film to be formed may be lowered.

The A-B block copolymer can be produced by, for example, a living radical polymerization method. Note that the A-B block copolymer is formed with acrylonitrile and methacrylic acid, and therefore it is easy to control the structure thereof, and it is also easy to adjust the molecular weight.

As the alkali for neutralizing at least part of the carboxy groups in the polymeric dispersant (polymer), conventionally known alkalis including, for example, ammonia; organic amines, such as triethylamine and dimethylaminoethanol; and alkali metal hydroxides, such as lithium hydroxide, sodium hydroxide, and potassium hydroxide, can be used. Among others, the alkali is preferably at least one selected from the group consisting of lithium hydroxide, sodium hydroxide, and potassium hydroxide from the viewpoint of, for example, improving water-solubility, and improving electrical conductivity of a coating film by the action of ions.

All of the carboxy groups in the polymer may be neutralized with the alkali, but it is also preferable to neutralize only part of the carboxy groups with the alkali within a range where the polymer can be dissolved in water. The carboxy groups (—COOH) not neutralized by the alkali can form hydrogen bonds with the carbon materials. For this reason, when the polymer in which only part of the carboxy groups are neutralized with the alkali is used as a dispersant, the dispersion stability of the carbon material dispersion can be improved further. The amount of the alkali for neutralizing the carboxy groups is preferably an amount corresponding to 50 to 120 mol % of the carboxy groups, more preferably an amount corresponding to 70 to 110 mol % of the carboxy groups.

The polymer which is used as a polymeric dispersant can be produced by a conventionally known method. The polymer can be produced by, among others, a solution polymerization method using an organic solvent; a radical polymerization method using an azo-based radical generator or a peroxide radical generator; and other methods. As the organic solvent, a conventionally known organic solvent can be used. However, the polymer may be difficult to dissolve in a general-purpose organic solvent, and therefore a water-soluble polar organic solvent is preferably used. Examples of such a polar organic solvent include an amide-based solvent, a sulfoxide-based solvent, a urea-based solvent, and nitrile-based solvent. It is preferable to use, among others, an amide-based solvent, a urea-based solvent, and a nitrile-based solvent. After the polymerization is performed in any of these organic solvents, an aqueous alkali solution is added to the polymerization solution to neutralize the carboxy groups and form an aqueous solution, and thereby a carbon material dispersion containing the organic solvent can be obtained.

Examples of the amide-based solvent include dimethylformamide, dimethylacetamide, diethylacetamide, N-methylpyrrolidone, 3-methoxy-N, N-dimethylpropanamide, and 3-butoxy-N, N-dimethylpropanamide. Examples of the urea-based solvent include tetramethyl urea and 1,3-dimethylimidazolidinone. Examples of the nitrile-based solvents include acetonitrile.

It is difficult to produce the A-B block copolymer which is used as a polymeric dispersant by an ordinary radical polymerization method. For this reason, the A-B block copolymer is preferably produced by a living polymerization method, such a anionic as living polymerization method, a living cationic polymerization method, and a living radical polymerization method. Among others, a living radical polymerization method is particularly preferable from the viewpoint of conditions, materials, apparatus, and the like.

Examples of the living radical polymerization method include an Atom Transfer Radical Polymerization method (ATRP method), a Reversible Addition-Fragmentation Chain Transfer Polymerization method (RAFT method), a Nitroxide-Mediated Polymerization method (NMP method), an Organotellurium-Mediated Living Radical Polymerization method (TERP method), a Reversible Chain Transfer Catalyzed Polymerization method (RTCP method), and a Reversible Complexation Mediated Polymerization method (RCMP method). Among others, the RTCP method and the RCMP method, in which an organic compound is used as a catalyst, and an organic iodide is used as a polymerization initiation compound, are preferable. These methods are advantageous in terms of costs and purification because a commercially available compound which is relatively safe is used, and a heavy metal and a special compound are not used. Furthermore, by using tertiary iodine as a growth terminal, block structures can be easily formed with good precision using general facilities.

In producing the A-B block copolymer, any of the polymerization for forming the polymer block A and the polymerization for forming the polymer block B may be performed first. However, when the polymerization for forming the polymer block B is performed first, methacrylic acid may remain in the polymerization system. In this case, a constituent unit derived from methacrylic acid may be introduced excessively into the polymer block A which is formed later. For this reason, the polymerization for forming the polymer block B is preferably performed after the polymerization for forming the polymer block A is first performed.

When the carbon materials contain SWCNT, the amount of the dispersant based on 100 parts by mass of SWCNT, (D/P), is preferably 30 to 200 parts by mass, more preferably 50 to 150 parts by mass. When the carbon materials contain MWCNT, the amount of the dispersant based on 100 parts by mass of MWCNT, (D/P), is preferably 30 to 200 parts by mass, more preferably 30 to 100 parts by mass. When the carbon materials contain CB, the amount of the dispersant based on 100 parts by mass of CB, (D/P), is preferably 10 to 200 parts by mass, more preferably 20 to 100 parts by mass. By allowing the amount of the dispersant based on the amount of each carbon material to fall within the above-described range, the carbon material dispersion can be prepared in which the carbon materials are dispersed more stably. When the amount of the dispersant based on the amount of each carbon material is too small, the dispersant cannot cover the surfaces of the carbon materials sufficiently, so that the dispersibility may be somewhat insufficient. On the other hand, when the amount of the dispersant based on the amount of each carbon material is too large, the viscosity of the carbon material dispersion may be likely to increase, and the ratio of each carbon material in the solid content may be relatively lowered. In addition, the surface resistivity of a coating film to be formed may be somewhat higher, and when an electrode is formed, the cycle characteristics of the electrode may be lowered.

### (Binder Resin)

The carbon material dispersion of the present embodiment contains a binder resin. When the carbon material dispersion contains a binder resin, thereby an electrically conductive coating film having excellent properties such as stretching and bending and having improved adhesion to a substrate or the like can be formed. As the binder resin, cellulose derivatives such as carboxymethyl cellulose (including Na salt); styrene/butadiene copolymers; and acrylic resins such as styrene/acrylic resins are preferably used taking, for example, the affinity to the dispersant into consideration.

When the carbon material dispersion is used as a coating film or a paint, the content of the binder resin in the carbon material dispersion is, for example, preferably 0.3 to 200 parts by mass, more preferably 3 to 100 parts by mass, based on 1 part by mass of the carbon materials. When the amount of the binder resin is too small, coating of a substrate may be difficult, and a uniform coating film may be unable to obtain. When the amount of the binder resin is too large, the ratio of each carbon material is relatively lowered, and therefore sufficient electrical conductivity may be unable to obtain when a coating film is formed. In battery applications, the content of the binder resin is, for example, preferably 0.5 to 500 parts by mass, more preferably 5 to 300 parts by mass, based on 1 part by mass of the carbon materials. When the amount of the binder resin is too small, coating of a substrate may be difficult, and a uniform electrode may be unable to obtain. When the amount of the binder resin is too large, the ratio of each active material (each carbon material) is relatively lowered, and therefore sufficient battery capacity may be unable to obtain when a battery is prepared.

### (Additive Etc.)

The carbon material dispersion of the present embodiment can further contain an additive, a resin, and the like. Examples of the additive include a water-soluble dye, a pigment, an ultraviolet absorber, a light stabilizer, an antioxidant, a levelling agent, a defoamer, an antiseptic, a mildew-proofing agent, a photopolymerization initiator, and other pigment dispersants. Examples of the resin include a polyolefin resin, a polyhalogenated olefin resin, a polyester resin, a polyamide resin, a polyimide resin, a polyether resin, a polyvinyl resin, a polystyrene resin, a polyvinyl alcohol resin, a polymethacrylate resin, a polyurethane resin, a polyepoxy resin, a polyphenol resin, a polyurea resin, and a polyethersulfone resin.

A defoamer is preferably contained as an additive in the carbon material dispersion according to the apparatus which is used in a wetting and dispersion step. When a defoamer is contained, foaming during dispersion treatment can be suppressed, and therefore shear force, collision force, and the like which are applied during dispersion treatment act effectively, so that a dispersion having more excellent dispersibility can be prepared.

### (Carbon Material Dispersion)

Absorbance of a dispersion of the carbon materials containing a carbon nanotube gives a gentle curve between wavelengths of 300 nm and 1,000 nm. However, this curve (absorbance curve) varies significantly depending on the dispersion state of the carbon nanotube. For example, the absorbance on the short wavelength side gives a large value when the amount of finely dispersed carbon nanotubes is large. On the other hand, the absorbance on the long wavelength side gives a large value when the amount of aggregates of the carbon nanotube is large. Accordingly, an absorbance ratio obtained by dividing the absorbance (A_{L}) on the short wavelength side by the absorbance (A_{H}) on the long wavelength side, (A_{L}/A_{H}), well reflects the dispersion state of the carbon materials in a liquid medium. Specifically, as the carbon nanotube is dispersed more finely and uniformly, the absorbance ratio is larger, and as the carbon nanotube forms more aggregates, the absorbance ratio is smaller.

The wavelength W_{M} which is a standard is defined as a median value of the wavelength W_{L} on the short wavelength side and the wavelength W_{H} on the long wavelength side (W_{M}=(W_{L}+W_{H})/2). In a wavelength region near the median value, there is hardly any influence of the dispersion state of the carbon materials, and therefore the absorbance ratio (A_{L}/A_{H}) is suitable as the standard for evaluating the dispersibility of the carbon materials.

The wavelength W_{L} on the short wavelength side is arbitrarily selected from within a range of 350 to 550 nm, preferably within a range of 350 to 450 nm, more preferably within a range of 350 to 400 nm. The absorbance at a wavelength within the above-described ranges changes distinctly and can be measured stably because there is less noise or peculiar peak variation. When the wavelength W_{L} is shorter than 350 nm, the peak varies greatly with the progress of dispersion due to an irregular influence of light absorption and scattering by fine particles, which makes it difficult to use the wavelength W_{L} as an accurate index. On the other hand, when the wavelength W_{L} is longer than 550 nm, the absorbance changes indistinctly.

The wavelength W_{H} on the long wavelength side is arbitrarily selected from within a range of 650 to 850 nm, preferably within a range of 700 to 850 nm, more preferably within a range of 700 to 800 nm. When the wavelength is within the above-described ranges, t the absorbance of particles giving a small proportion of the absorption component and a large proportion of the scattering component can be checked. In addition, there is less noise or peculiar peak variation, so that measurement can stably be performed. When the wavelength W_{H} on the long wavelength side is longer than 850 nm, noise is mixed in the peak, which makes it difficult to measure an accurate value. On the other hand, the range where the wavelength W_{H} on the long wavelength side is shorter than 650 nm is not suitable as the index.

The difference between the wavelength W_{L} and the wavelength W_{H} is preferably 100 nm or more, more preferably 200 nm or more. By setting the difference between the wavelength W_{L} and the wavelength W_{H} to 100 nm or more, the dispersibility of the carbon materials can be read more accurately. When the difference between the wavelength W_{L} and the wavelength W_{H} is too small, it may be difficult to evaluate the dispersion state of the carbon materials precisely.

The absorbance of the dispersion varies depending on the content (concentration) of the carbon materials. For this reason, the absorbance of a dilute dispersion prepared by diluting a dispersion not containing the binder resin and the absorbance of a dilute dispersion prepared by diluting the dispersion containing the binder resin are measured. As a diluent for diluting each dispersion, a blank solution having the same composition as that of the dispersion to be an object except that the carbon materials are not contained is preferably used. By using such a blank solution, influences of diffusion, reaggregation, and environment of fine particles on the absorbance are suppressed, and the absorbance is made unsusceptible to an influence of a polymeric dispersant, which may be used as a dispersant, so that the absorbance can be measured more accurately.

To measure the absorbance accurately, it is preferable to set the content of the carbon materials in a sample solution (dilute dispersion) usually within a range of 0.001 to 0.01% by mass. When the content is more than 0.01%, the quantity of scattering laser light transmitting during measurement is small, which may make it difficult to perform the measurement accurately. On the other hand, when the content is less than 0.001% by mass, the value of absorbance is too small, which may make it difficult to perform accurate evaluation or comparison.

The absorbance at the wavelength W_{M} of the dilute dispersion obtained by diluting the carbon material dispersion with a diluent containing a liquid medium is 1.2 to 2.2, preferably 1.5 to 2.0. When the absorbance at the wavelength W_{M} of the dilute dispersion is less than 1.2, it is difficult to determine the dispersion state. On the other hand, it is difficult to measure an absorbance of higher than 2.2 accurately.

The value of the ratio of absorbance A_{L} at the wavelength W_{L} to absorbance Ar at the wavelength W_{H}, (A_{L}/A_{H}), in a dilute dispersion varies according to the wavelengths W_{H} and W_{L}. For example, when the value of “A_{L}/A_{H}” at the wavelength W_{L}=380 nm and the wavelength W_{H}=780 nm is “1.60,” the value of “A_{L}/A_{H}” at the wavelength W_{L}=400 nm and the wavelength W_{H}=700 nm is “1.44,” and the value of “A_{L}/A_{H}” at the wavelength W_{L}=350 nm and the wavelength W_{H}=800 nm is “1.78.” When the value of “A_{L}/A_{H}” at the wavelength W_{L}=380 nm and the wavelength W_{H}=780 nm is “1.65,” the value of “A_{L}/A_{H}” at the wavelength W_{L}=400 nm and the wavelength W_{H}=700 nm is “1.48,” and the value of “A_{L}/A_{H}” at the wavelength W_{L}=350 nm and the wavelength W_{H}=800 nm is “1.85.”

The absorbance at the wavelength W_{L} of the dilute dispersion is a physical property value which is an index of the dispersion state of the carbon materials. On the other hand, the absorbance at the wavelength W_{H} of the dilute dispersion is a physical property value which is an index of the aggregation state of the carbon materials. By using the wavelength W_{M}, which is a median value of the wavelengths W_{L} and W_{H}, as a standard to obtain the value of the ratio of absorbance A_{L} at the wavelength W_{L} to absorbance A_{H} at the wavelength W_{H}, (A_{L}/A_{H}), for the dilute dispersion obtained by diluting the carbon material dispersion with a diluent containing a liquid medium such that absorbance at the wavelength W_{M} is 1.2 to 2.2, the dispersion state of the carbon materials in this dispersion can be accurately evaluated.

When the wavelength W_{L} is 380 nm, the wavelength W_{H} is 780 nm, the wavelength W_{M} is 580 nm, and absorbance at the wavelength W_{H} is 1.5 to 2.0 (preferably, 1.8±0.02) for the dilute dispersion, the ratio of absorbance A_{L} to absorbance A_{H}, (A₃₈₀/A₇₈₀), is preferably 1.40 or more, more preferably 1.48 or more, particularly preferably 1.55 or more. By setting the value of the absorbance ratio (A₃₈₀/A₇₈₀) to the above-described ranges, a dispersion substantially free of a coarse aggregate and more excellent in viscosity stability can be prepared even when the types and addition amounts of the carbon materials, the dispersant, and the binder resin vary.

The higher the absorbance ratio of the dispersion, the better, regardless of whether the dispersion contains the binder resin or not. Even if the binder resin is added to a dispersion with poor dispersibility which does not contain the binder resin, the absorbance ratio is hardly improved, and the dispersion may be unable to exhibit sufficient performance.

The dispersion of the present embodiment has excellent viscosity stability (storage stability) because the viscosity is unlikely to change even after a long period of time. Specifically, the change rate of the viscosity (mPa·s) at 25° C. of the dispersion which does not contain the binder resin after the elapse of 10 days under a room temperature (25° C.) condition based on the viscosity (mPa·s) at 25° C. of the dispersion immediately after preparation (dispersion) and the dispersion after the binder resin is added is usually 15% or less, preferably 10% or less, still more preferably 5% or less.

If aggregates having a short side of 100 μm or larger are present in the dispersion, intrinsic performance, such as electrical conductivity and thermal conductivity, of the carbon nanotube is unlikely to be exhibited when the dispersion is applied to various applications; and growth or sedimentation of the aggregates occurs and therefore the viscosity stability and the storage stability are likely to be lowered. For example, when a dispersion containing aggregates having a short side of 100 μm or larger is used as a coating material, there is a tendency that uniform coating is difficult. In contrast, the dispersion of the present embodiment is substantially free of a coarse aggregate formed by the carbon materials containing a carbon nanotube. Specifically, even when the dispersion immediately after preparation (dispersion), the dispersion after the binder resin is added, and the respective dispersions after the elapse of 10 days under a room temperature (25° C.) condition are observed 5 times at a magnification of 200× using an optical microscope, not an aggregate having a short side of 100 μm or larger is usually observed. Preferably, (average value) of aggregates having a short side of 20 μm or larger is 10 or more per observation. More preferably, the number (average value) of aggregates having a short side of 20 μm or more is one or more and less than 10 per observation, and particularly preferably, not a single aggregate having a short side of 20 μm or more is observed even when the observation is performed 5 times.

### (Method for Producing Carbon Material Dispersion)

The carbon material dispersion can be produced by preliminarily wetting and then dispersing the carbon materials containing a carbon nanotube in the liquid medium using the dispersant according to a conventionally known method, and thereafter adding the binder resin. For example, stirring with a magnetic stirrer; stirring with a dissolver; three-roll kneading; ultrasonic dispersion; dispersion with a bead mill; and a wetting method, a dispersing method, and a mixing method each using an emulsification apparatus, a homogenizer, or the like can be used. From the viewpoint of simplicity of the process, it is preferable to stir and wet the carbon materials containing a carbon nanotube with a magnetic stirrer, a dissolver, or a homogenizer, and it is preferable to disperse the carbon materials containing a carbon nanotube in combination with a high-pressure homogenizer. For example, it is preferable to disperse the carbon materials containing a carbon nanotube with a bead mill using beads having a small particle diameter. In addition, wetting and stirring may be combined with a method of highly dispersing the carbon materials containing a carbon nanotube taking damage to the carbon materials, such as a carbon nanotube into consideration.

In addition, the carbon material dispersion to be a target is preferably produced in such a way that a plurality of dispersions is obtained by dispersing each carbon material individually in an aqueous medium, and then the resulting dispersions are mixed. Specifically, the dispersion of the present embodiment is preferably obtained by mixing a first dispersion containing at least one of the carbon materials and a second dispersion containing at least one of the carbon materials, different from the carbon material in the first dispersion. By mixing a plurality of dispersions each obtained through dispersion treatment performed under appropriate conditions according to the type or types of the carbon material or carbon materials, a dispersion having more excellent dispersibility can be prepared. The mechanism or the like by which a dispersion having further improved dispersibility of the carbon materials can be obtained by mixing a plurality of dispersions (first dispersion and second dispersion) has not necessarily clear, and it is substantially difficult or impossible to grasp the mechanism or the like by analysis or the like. Note that when a dispersion containing the three types of the carbon materials (SWCNT, MWCNT, and CB) is produced, a first dispersion, a second dispersion, and a third dispersion each containing one of the three types of the carbon materials may be mixed.

In mixing a plurality of dispersions, a disperser may be used besides a magnetic stirrer. Mixing with a disperser is preferable because it can prevent aggregation caused by shock, and the like, so that a dispersion which gives a more excellent dispersion state can be obtained.

### (Coating Film)

An electrically conductive coating film (film) can be formed by applying and drying the carbon material dispersion of the present embodiment. The concentration of the carbon materials in the formed coating film is, for example, preferably 1 to 10% by mass, more preferably 2 to 7% by mass, particularly preferably 3 to 5% by mass. The thickness (film thickness) of the coating film can be, for example, 1 to 10 μm. The thicker the film thickness and the higher the concentration of the carbon materials, the lower the surface resistivity of the coating film. It has been ascertained that when the film thickness is within a range of 110.2 μm and the concentration of the carbon materials is within a range of 3±0.1% by mass, the surface resistivity of the coating film hardly changes.

The surface resistivity of a dry film (coating film) formed by applying and drying the carbon material dispersion of the present embodiment, the dry film containing 3% by mass of the carbon materials and having a thickness of 1 μm, is 1.0×10⁶ Ω/sq or less, preferably 5.0×10⁵ Ω/sq or less. The surface resistivity of a dry film formed by applying and drying the carbon material dispersion of the present embodiment, the dry film containing 3% by mass of the carbon materials and having a thickness of 10 μm, is preferably 1.0×10³ Ω/sq or less, more preferably 1.0×10² Ω/sq or less. The content of the carbon materials in the dry film (coating film) can be calculated by subtracting the mass (solid content) of the dispersant used from the mass of the dry film formed by heating the coating film, which is formed by applying the dispersion, to evaporate the aqueous liquid medium.

### <Use of Carbon Material Dispersion>

In the carbon material dispersion of the present embodiment, the carbon materials a containing carbon nanotube are well-dispersed without substantially producing a coarse aggregate, and therefore the carbon material dispersion of the present embodiment has excellent viscosity stability. In addition, the carbon material dispersion of the present embodiment is a water-based dispersion and therefore is an environmentally friendly material and useful as a material for producing a paint, an ink, a coating agent, a material for a resin shaped article, and the like. Moreover, utilization of the carbon material dispersion of the present embodiment as an electrically conductive material or a thermally conductive material can be expected, and besides, the application to antistatic materials can also be expected. Furthermore, the carbon material dispersion of the present embodiment is useful as a material for forming a film that forms battery materials or capacitor materials, such as an electrode material for forming a battery such as a lithium ion battery or a fuel cell. The carbon material dispersion of the present embodiment is also useful as a material for forming a film that forms various mechanical components.

An aqueous paint or ink can be prepared by, for example, adding various components, such as a solvent, a resin, and an additive, to the carbon material dispersion. The carbon material dispersion may be added to a commercially available paint or ink.

A resin shaped article can be produced by, for example, adding the carbon material dispersion to a molten plastic material and then removing water. A resin shaped article in which the carbon materials are dispersed can also be produced by adding the carbon material dispersion to a fine powder of a plastic material and then removing water or precipitating the carbon materials.

### EXAMPLES

Hereinafter, the present invention will be specifically described based on Examples, but the present invention is not limited to these Examples. Note that the “part(s)” and “%” in Examples and Comparative Examples are each on a mass basis unless otherwise noted.

### <Preparation of Materials>

The following carbon materials, dispersants, and binder resins were prepared.

### (Carbon Materials)

### [Single-Walled Carbon Nanotube (SWCNT)]

SWCNT-1: trade name “Tuball,” manufactured by OCSiAl.
SWCNT-2: trade name “SG101,” manufactured by Zeon Corporation

### [Multi-Walled Carbon Nanotube (MWCNT)]

MWCNT-1: trade name “100T,” manufactured by KUMHO
MWCNT-2: trade name “400T,” manufactured by KUMHO.
MWCNT-3: trade name “6A,” manufactured by JEIO
MWCNT-4: trade name “Multi-Walled Carbon Nanotube Flake,” manufactured by Hamamatsu Carbonics Corporation

### [Carbon Black]

CB-1: trade name “Li435,” manufactured by Denka Company Limited
CB-2: trade name “HS-100,” manufactured by Denka Company Limited
CB-3: trade name “Vulcan XC-72,” manufactured by CABOT Corporation.
CB-4: trade name “Ketjenblack EC-300J,” manufactured by LION SPECIALTY CHEMICALS CO., LTD.

### (Dispersant)

Dispersant d: trade name “FLOWLEN GW-1500,” manufactured by Kyoeisha Chemical Co., Ltd., solid content 100%
Dispersant e: trade name “DISPARLON AQ-380,” manufactured by Kusumoto Chemicals, Ltd., solid content 30% (Binder Resin)
Binder A: trade name “YL-1098,” styrene/acrylic resin, manufactured by Seiko PMC Corporation
Binder B: Dispersant c
   Binder C: Mixture of dispersant c and styrene/butadiene copolymer latex (trade name “SR-112,” manufactured by NIPPON A&L INC.) (dispersant C: styrene/butadiene copolymer latex=4:1)

### <Production (1) of Dispersant>

### (Dispersant a)

In a reaction container, 233.3 parts of N-methylpyrrolidone (NMP) was placed and stirred, and the temperature was increased to 70° C. In a beaker, 60 parts of acrylonitrile (AN), 40 parts of acrylic acid (AA), and 3.0 parts of 2,2′-azobis(2,4-dimethylvaleronitrile) (trade name “V-65,” manufactured by FUJIFILM Wako Pure Chemical Corporation) (V-65) were placed, and V-65 was completely dissolved to prepare a monomer solution. The prepared monomer solution was placed in a dropping funnel, and when the temperature in the reaction container reached 70° C., ⅓ of the total amount was put into the reaction container, and the remaining solution was dropped over 1.5 hours. V-65 in an amount of 1.0 part was added 2.5 hours after completion of the dropping. After the temperature of the resulting mixture was kept at 70° C. for 1 hour, the temperature was increased to 80° C. and kept there for 2 hours to form a polymer. After the reaction solution was cooled, the solid content was measured using a moisture meter to ascertain that almost all the monomers were consumed. The number average molecular weight (Mn) in terms of polymethyl methacrylate and polydispersity index (PDI=weight average molecular weight (Mw)/number average molecular weight (Mn)) of the polymer were 25, 300 and 2.24 respectively, as measured by gel permeation chromatography (GPC) using an N, N-dimethylformamide solution of lithium bromide (concentration of lithium bromide: 10 mmol/L) as a developing solvent.

In a beaker, 24.4 parts (110 mol % based on AA) of sodium hydroxide (NaOH) and 96.8 parts of ion-exchanged water were placed, and NaOH was completely dissolved to prepare an aqueous NaOH solution. After the temperature in the reaction container became 60° C. or lower, the aqueous NaOH solution was put into the reaction container to neutralize carboxy groups, and thus a solution of a polymeric dispersant (dispersant a) was obtained. The solid content of the obtained solution of dispersant a was 22.1%.

### (Dispersant b)

In a reaction container, 255.4 parts of 3-methoxy-N, N-dimethylpropanamide (MDMPA), 1.0 part of iodine, 3.7 parts of 2,2′-azobis(4-methoxy-2,4-dimethylvaleronitrile) (trade name “V-70,” manufactured by FUJIFILM Wako Pure Chemical Corporation) (V-70), 0.2 parts s of diphenylmethane (DPM), 106.1 parts of AN, and 26.5 parts of methacrylic acid (MAA) were placed. The resulting mixture was stirred in a nitrogen gas stream, the temperature was increased to 40° C. to perform polymerization for 4 hours, and thus a chain A was formed. The solid content of the reaction solution was 34.8%, and the conversion rate of the polymerization calculated from the solid content was about 100%. Mn, PDI, and peak top molecular weight (PT) of the formed chain A were 14, 800, 1.41, and 20, 700, respectively.

After 3.1 parts of V-70 was added, a monomer solution containing 30.0 parts of AN, 31.8 part of MAA, and 216.9 parts of MDMPA was further added. Thereafter, polymerization was performed at 40° C. for 4 hours to form a chain B, and thus an A-B block copolymer was obtained. The solid content of the reaction solution was 29.9%, and thereby it was ascertained that a target product was obtained almost quantitatively. Mn, PDI, and PT of the obtained A-B block copolymer were 21, 600, 1.52, and 32, 700, respectively. The molecular weight of the chain B can be calculated by subtracting Mn of the chain A from Mn of the A-B block copolymer. Specifically, Mn and PT of the chain B were 6, 800 and 12,000, respectively.

In a beaker, 29.8 parts (110 mol % based on MAA) of NaOH and 105.1 parts of ion-exchanged water were placed, and NaOH was completely dissolved to prepare an aqueous NaOH solution. The aqueous NaOH solution was put into the reaction container to neutralize carboxy groups, and thus a solution of a polymeric dispersant (dispersant b) was obtained. The solid content of the obtained solution of dispersant b was 25.1%.

### (Dispersant c)

In a 1 L stainless steel container equipped with a stirrer, 400 g of isopropyl alcohol (IPA) and 60 g of water were placed, and 10 g of sodium hydroxide (purity 98%) was put thereinto while the stainless steel container was cooled. The solution was cooled to 25° C. or lower, and then 20 g of pulverized pulp was put thereinto under stirring.

Subsequently, the resulting mixture was stirred and mixed at 15 to 25° C. for 60 minutes (mercerization) to prepare alkali cellulose. Subsequently, 30 g of a mixed solution of monochloroacetic acid/isopropyl alcohol=1:2 was put into the stainless steel container while the stainless steel container was cooled to keep the temperature at 15 to 25° C., and the resulting solution was stirred and mixed for 15 minutes. Subsequently, the temperature of the solution was increased to 70° C. over about 30 minutes while the stainless steel container was heated. The solution was stirred at 65 to 75° C. for 120 minutes to perform etherification reaction. After the reaction was completed, unreacted sodium hydroxide was neutralized with acetic acid to separate a product. The product was washed with a 70% aqueous solution of methanol to remove by-products. The product was dried and pulverized to obtain carboxymethyl cellulose sodium salt (dispersant c). The viscosity of a 1% aqueous solution and degree of etherification (DS) of the obtained carboxymethyl cellulose sodium salt were 31 mPa·s and 0.84, respectively.

The degree of etherification was measured with reference to Testing Methods for JIS-related Materials of Synthetic Detergents described in Journal of Japan Oil Chemist's Society 38(11), 962-967(1989). Specifically, about 1 g of carboxymethyl cellulose e sodium salt was precisely weighed and placed in a porcelain crucible and then heated at a temperature (about 550 to about 590° C.) not exceeding 600° C. for 1 hour for ashing. The ash was cooled to room temperature and transferred to a 500 ml beaker together with the crucible to add 250 ml of water. Then, 50 mL of a 0.05 mol/L aqueous sulfuric acid solution was added, and then boiling was performed for 30 minutes. After cooling was performed to room temperature, unreacted acid was titrated using 0.1 mol/L sodium hydroxide. Phenolphthalein was used as an indicator. The degree of etherification (DS) was calculated by the following formula, assuming the amount of 0.1 mol/L sodium hydroxide used for the titration to be “X” mL.

Degree of etherification (DS)=162X/(10000−80X)

### <Measurement and Evaluation Methods>

### (Measurement of Absorbance and Calculation of Absorbance Ratio)

A blank solution having the same composition as that of the dispersion except that the carbon materials were not contained was prepared. After a base line was measured using the prepared blank solution, the absorbance of the sample solution was measured. The absorbance of the sample solution was measured using a spectrophotometer (trade name “Hitachi Spectrophotometer U-3310,” manufactured by Hitachi High-Tech Science Corporation) equipped including a quartz cell having an optical path length of 10 mm. As for dilution with the blank solution, a calibration curve is created by plotting the absorbance at a wavelength of 580 nm against changes in dilution ratio to calculate a dilution ratio where the absorbance is 1.8±0.02, and a dispersion diluted to an intended concentration was prepared. In addition, it is also possible to perform dispersion after adjusting the carbon constituent concentration as intended at a stage before dispersing the carbon materials or after adjusting the carbon constituent concentration so as to satisfy the above-described absorbance at an initial blending stage. The specific method for preparing the sample solution was as follows: first, the dispersion was taken in a polyethylene bottle, and an appropriate amount of the blank solution was added based on the dilution ratio determined from the calibration curve; and the resulting mixture was stirred for 30 seconds using Vortex Mixer (manufactured by Scientific Industries, Inc.) to obtain the sample solution such that absorbance A₅₈₀ at a wavelength of 580 nm was 1.8±0.02. Absorbance A₃₈₀ at a wavelength of 380 nm and absorbance A₇₈₀ at a wavelength of 780 nm of the obtained sample solution were measured n absorbance ratio (A₃₈₀/A₇₈₀) was calculated. The measurement was performed for the dispersion immediately after dispersion and the dispersion after adding the binder resin.

### (Evaluation of Dispersion)

### [Measurement of Viscosity and Evaluation of Viscosity Stability]

The viscosity was measured for the dispersion immediately after dispersion, the dispersion after adding the binder resin, and the respective dispersions after 10 days (after being left to stand still at room temperature for 10 days) using an E-type viscometer equipped with a rotor of 1°34′×R24 under the conditions of a temperature of 25° C. and a rotor revolution rate of 100 rpm. Note that as for dispersions having a viscosity of lower than 25 mPa·s, the viscosity was measured using “VISCOMETER TVE-25L,” trade name (manufactured by Toki Sangyo Co., Ltd); and as for dispersions having a viscosity of 25 mPa·s or higher, the viscosity was measured using “VISCOMETER TVE-25H,” trade name (manufactured by Toki Sangyo Co., Ltd). The viscosity stability of each dispersion was evaluated according to the evaluation criteria described below.
Excellent: the viscosity change rate after 10 days based on the viscosity immediately after dispersion is less than 5%
Good: the viscosity change rate after 10 days based on the viscosity immediately after dispersion is 5% or more and less than 10%
Fair: the viscosity change rate after 10 days based on the viscosity immediately after dispersion is 10% or more and less than 15%
Poor: the viscosity change rate after 10 days based on the viscosity immediately after dispersion is 15% or more

### [Observation of Aggregates]

The dispersion immediately after dispersion and the dispersion after adding the binder resin were each taken in a polyethylene bottle and diluted by adding the blank solution in such a way as to make the concentration of the carbon materials 0.1% by mass. The resulting mixture was stirred for 30 seconds using a Vortex mixer (manufactured by Scientific Industries, Inc.) to obtain a diluted solution. Onto a microscope slide, 30 UL of the diluted solution obtained was dropped, and a cover slip was put thereon to observe (200×) whether an aggregate was present or not using an optical microscope. A sample obtained by dropping the diluted solution onto a microscope slide was prepared 5 times for each of the dispersion immediately after dispersion, the dispersion after adding the binder resin, and the respective dispersions after 10 days (after being left to stand still at room temperature for 10 days), and the samples were observed to evaluate whether an aggregate was present or not according to the evaluation criteria described below.

Excellent: an aggregate having a short side of 20 μm or longer is not observed in 5 observations.

Good: the number (average value) of aggregates having a short side of 20 μm or longer is one or more and less than 10 per observation, and an aggregate having a short side of 100 μm or longer is not observed in 5 observations.

Fair: the number (average value) of aggregates having a short side of 20 μm or longer is 10 or more per observation, and an aggregate having a short side of 100 μm or longer is not observed in 5 observations.

Poor: one or more aggregates having a short side of 100 μm or longer are observed in 5 observations.

### (Evaluation of Coating Film)

### [Measurement of Surface Resistivity]

When the surface resistivity was higher than 105 Ω/sq, a resistivity meter for a high resistivity range (trade name “Hiresta-UP MCP-HT450,” manufactured by Nittoseiko Analytech Co., Ltd.) was used to calculate the average value of the surface resistivity of the coating film measured at 5 points with an applied voltage of 10 V. When the surface resistivity was 10⁵ Ω/sq or lower, a resistivity meter for a low resistivity range (trade name “Loresta-GP MCP-T610,” manufactured by Nittoseiko Analytech Co., Ltd.) was used to calculate the average value of the surface resistivity of the coating film measured at 5 points with an applied voltage of 10 V.

### <Preparation and Evaluation (1) of Dispersion>

### (Dispersions 1 to 25)

The dispersant of the type and amount shown in Table 1 and water of the amount shown in Table 1 were placed in a 200 mL polyethylene bottle. The resulting mixture was stirred with a magnetic stirrer until the mixture became uniform, and then the carbon material of the type and amount shown in Table 1 was added, and the resulting mixture was further stirred. Subsequently, high-pressure treatment was performed using a high-pressure homogenizer (manufactured by JOKOH CO., LTD.) under a condition of a treatment pressure of about 10 MPa. Thereafter, high-pressure dispersion treatment was performed using a high-pressure homogenizer (manufactured by SUGINO MACHINE LIMITED) under a condition of a treatment pressure of about 100 MPa to obtain a dispersion not containing a binder resin.

TABLE 1

| | Carbon material | | Dispersant | | Water |
|---|---|---|---|---|---|
| | | Amount | | Amount | Amount |
| | Type | (parts) | Type | (parts) | (parts) |
| Dispersion 1 | SWCNT-1 | 0.4 | a | 2.7 | 96.9 |
| Dispersion 2 | SWCNT-1 | 0.4 | b | 2.4 | 97.2 |
| Dispersion 3 | SWCNT-1 | 0.4 | b | 6.4 | 93.2 |
| Dispersion 4 | SWCNT-1 | 0.4 | c | 0.6 | 99.0 |
| Dispersion 5 | SWCNT-2 | 0.4 | b | 2.4 | 97.2 |
| Dispersion 6 | SWCNT-2 | 0.4 | e | 2.0 | 97.6 |
| Dispersion 7 | MWCNT-1 | 1.0 | a | 4.5 | 94.5 |
| Dispersion 8 | MWCNT-1 | 1.0 | b | 2.0 | 97.0 |
| Dispersion 9 | MWCNT-1 | 1.0 | b | 4.0 | 95.0 |
| Dispersion 10 | MWCNT-1 | 1.0 | b | 12.0 | 87.0 |
| Dispersion 11 | MWCNT-1 | 1.0 | c | 1.0 | 98.0 |
| Dispersion 12 | MWCNT-1 | 1.0 | d | 1.0 | 98.0 |
| Dispersion 13 | MWCNT-2 | 1.0 | b | 4.0 | 95.0 |
| Dispersion 14 | MWCNT-3 | 1.0 | b | 4.0 | 95.0 |
| Dispersion 15 | MWCNT-4 | 1.0 | b | 4.0 | 95.0 |
| Dispersion 16 | CB-1 | 6.0 | a | 8.1 | 85.9 |
| Dispersion 17 | CB-1 | 6.0 | b | 7.2 | 86.8 |
| Dispersion 18 | CB-1 | 6.0 | b | 71.7 | 22.3 |
| Dispersion 19 | CB-1 | 6.0 | d | 1.8 | 92.2 |
| Dispersion 20 | CB-2 | 6.0 | b | 7.2 | 86.8 |
| Dispersion 21 | CB-3 | 6.0 | b | 7.2 | 86.8 |
| Dispersion 22 | CB-4 | 6.0 | b | 7.2 | 86.8 |
| Dispersion 23 | SWCNT-1 | 0.4 | b | 4.0 | 95.6 |
| Dispersion 24 | CB-1 | 6.0 | b | 23.9 | 70.1 |
| Dispersion 25 | SWCNT-1 | 0.4 | b | 1.6 | 98.0 |

### (Mixed Liquids 1 to 39)

The first dispersion and second dispersion of the types shown in Table 2, which are dispersions before adding a binder resin, were blended so as to give the mass ratio of carbon material 1 to carbon material 2 as shown in Table 2 and then mixed using a magnetic stirrer to obtain a mixed liquid. Table 3 shows the results of evaluation of viscosity stability, the results of observation of aggregates, and the absorbance ratios (A₃₈₀/A₇₈₀) for part of the obtained mixed liquids.

TABLE 2

| | | | | | | | Carbon material |
|---|---|---|---|---|---|---|---|
| | First dispersion | | | Second dispersion | | | 1:carbon |
| | | Carbon | Dispersant | | Carbon | Dispersant | material 2 |
| | Type | material 1 | 1 | Type | material 2 | 2 | (mass ratio) |
| Mixed liquid 1 | Dispersion 1 | SWCNT-1 | a | Dispersion 16 | CB-1 | a | 9:1 |
| Mixed liquid 2 | Dispersion 2 | SWCNT-1 | b | Dispersion 17 | CB-1 | b | 9:1 |
| Mixed liquid 3 | Dispersion 2 | SWCNT-1 | b | Dispersion 20 | CB-2 | b | 9:1 |
| Mixed liquid 4 | Dispersion 2 | SWCNT-1 | b | Dispersion 21 | CB-3 | b | 9:1 |
| Mixed liquid 5 | Dispersion 2 | SWCNT-1 | b | Dispersion 22 | CB-4 | b | 9:1 |
| Mixed liquid 6 | Dispersion 2 | SWCNT-1 | b | Dispersion 9 | MWCNT-1 | b | 1:30 |
| Mixed liquid 7 | Dispersion 4 | SWCNT-1 | c | Dispersion 11 | MWCNT-1 | c | 1:30 |
| Mixed liquid 8 | Dispersion 2 | SWCNT-1 | b | Dispersion 15 | MWCNT-4 | b | 1:30 |
| Mixed liquid 9 | Dispersion 5 | SWCNT-2 | b | Dispersion 17 | CB-1 | b | 9:1 |
| Mixed liquid 10 | Dispersion 5 | SWCNT-2 | b | Dispersion 20 | CB-2 | b | 9:1 |
| Mixed liquid 11 | Dispersion 5 | SWCNT-2 | b | Dispersion 21 | CB-3 | b | 9:1 |
| Mixed liquid 12 | Dispersion 5 | SWCNT-2 | b | Dispersion 22 | CB-4 | b | 9:1 |
| Mixed liquid 13 | Dispersion 6 | SWCNT-2 | e | Dispersion 17 | CB-1 | b | 9:1 |
| Mixed liquid 14 | Dispersion 7 | MWCNT-1 | a | Dispersion 16 | CB-1 | a | 9:1 |
| Mixed liquid 15 | Dispersion 9 | MWCNT-1 | b | Dispersion 17 | CB-1 | b | 9:1 |
| Mixed liquid 16 | Dispersion 9 | MWCNT-1 | b | Dispersion 20 | CB-2 | b | 9:1 |
| Mixed liquid 17 | Dispersion 9 | MWCNT-1 | b | Dispersion 21 | CB-3 | b | 9:1 |
| Mixed liquid 18 | Dispersion 9 | MWCNT-1 | b | Dispersion 22 | CB-4 | b | 9:1 |
| Mixed liquid 19 | Dispersion 13 | MWCNT-2 | b | Dispersion 17 | CB-1 | b | 9:1 |
| Mixed liquid 20 | Dispersion 14 | MWCNT-3 | b | Dispersion 17 | CB-1 | b | 9:1 |
| Mixed liquid 21 | Dispersion 15 | MWCNT-4 | b | Dispersion 17 | CB-1 | b | 9:1 |
| Mixed liquid 22 | Dispersion 15 | MWCNT-4 | b | Dispersion 20 | CB-2 | b | 9:1 |
| Mixed liquid 23 | Dispersion 15 | MWCNT-4 | b | Dispersion 21 | CB-3 | b | 9:1 |
| Mixed liquid 24 | Dispersion 15 | MWCNT-4 | b | Dispersion 22 | CB-4 | b | 9:1 |
| Mixed liquid 25 | Dispersion 4 | SWCNT-1 | c | Dispersion 19 | CB-1 | d | 9.5:0.5 |
| Mixed liquid 26 | Dispersion 4 | SWCNT-1 | c | Dispersion 19 | CB-1 | d | 9:1 |
| Mixed liquid 27 | Dispersion 4 | SWCNT-1 | c | Dispersion 19 | CB-1 | d | 8:2 |
| Mixed liquid 28 | Dispersion 12 | MWCNT-1 | d | Dispersion 19 | CB-1 | d | 9.5:0.5 |
| Mixed liquid 29 | Dispersion 12 | MWCNT-1 | d | Dispersion 19 | CB-1 | d | 9:1 |
| Mixed liquid 30 | Dispersion 12 | MWCNT-1 | d | Dispersion 19 | CB-1 | d | 8:2 |
| Mixed liquid 31 | Dispersion 3 | SWCNT-1 | b | Dispersion 17 | CB-1 | b | 9:1 |
| Mixed liquid 32 | Dispersion 2 | SWCNT-1 | b | Dispersion 18 | CB-1 | b | 9:1 |
| Mixed liquid 33 | Dispersion 8 | MWCNT-1 | b | Dispersion 17 | CB-1 | b | 9:1 |
| Mixed liquid 34 | Dispersion 9 | MWCNT-1 | b | Dispersion 18 | CB-1 | b | 9:1 |
| Mixed liquid 35 | Dispersion 10 | MWCNT-1 | b | Dispersion 17 | CB-1 | b | 9:1 |
| Mixed liquid 36 | Dispersion 2 | SWCNT-1 | b | — | — | — | 10:0 |
| Mixed liquid 37 | Dispersion 4 | SWCNT-1 | c | Dispersion 19 | CB-1 | d | 5:5 |
| Mixed liquid 38 | Dispersion 12 | MWCNT-1 | d | — | — | — | 10:0 |
| Mixed liquid 39 | Dispersion 12 | MWCNT-1 | d | Dispersion 19 | CB-1 | d | 5:5 |

TABLE 3

| | Viscosity | Observation | Absorbance ratio |
|---|---|---|---|
| | stability | of aggregates | (A₃₈₀/A₇₈₀) |
| Mixed liquid 1 | Good | Excellent | 1.694 |
| Mixed liquid 2 | Excellent | Excellent | 1.703 |
| Mixed liquid 6 | Good | Excellent | 1.731 |
| Mixed liquid 14 | Good | Excellent | 1.719 |
| Mixed liquid 15 | Excellent | Excellent | 1.731 |
| Mixed liquid 26 | Good | Good | 1.737 |
| Mixed liquid 32 | Fair | Good | 1.717 |
| Mixed liquid 33 | Excellent | Excellent | 1.699 |
| Mixed liquid 34 | Good | Excellent | 1.733 |
| Mixed liquid 35 | Fair | Good | 1.745 |
| Mixed liquid 37 | Good | Good | 1.479 |
| Mixed liquid 39 | Good | Excellent | 1.465 |

### Examples 1 to 37, Reference Examples 1 to 8, and Comparative Examples 1 to 4

The mixed liquid and binder of the types shown in Table 4 were blended in a ratio such that the concentration of the carbon materials in the coating film (solid content) to be formed gave a value (%) shown in Table 4 and then mixed using a magnetic stirrer to obtain a carbon material dispersion. The obtained carbon material dispersion was applied on a PET film with a thickness of 100 μm (trade name “Lumirror,” manufactured by Toray Industries, Inc.) using a bar coater and then dried in an electric oven set at 90° C. for 30 minutes to remove volatile components, and thus a coating film having a film thickness shown in Table 4 was formed. The surface resistivity of the formed coating film is shown in Table 4. Table 5 shows the results of evaluation of viscosity stability, the results of observation of aggregates, and the absorbance ratios (A₃₈₀/A₇₈₀) for part of the obtained carbon material dispersions.

TABLE 4

| | | | | | | | Concentration | | |
|---|---|---|---|---|---|---|---|---|---|
| | Mixed liquid | | | | | | (%) of carbon | Film | Surface |
| | | Carbon | Dispersant | Carbon | Dispersant | | materials in | thickness | resistivity |
| | Type | material 1 | 1 | material 2 | 2 | Binder | coating film | (μm) | (Ω/sq) |
| Example 1 | Mixed liquid 1 | SWCNT-1 | a | CB-1 | a | A | 3 | 1 | 9.1 × 10⁵ |
| Example 2 | Mixed liquid 2 | SWCNT-1 | b | CB-1 | b | A | 3 | 1 | 7.8 × 10⁵ |
| Example 3 | Mixed liquid 3 | SWCNT-1 | b | CB-2 | b | A | 3 | 1 | 9.0 × 10⁵ |
| Example 4 | Mixed liquid 4 | SWCNT-1 | b | CB-3 | b | A | 3 | 1 | 9.8 × 10⁵ |
| Example 5 | Mixed liquid 5 | SWCNT-1 | b | CB-4 | b | A | 3 | 1 | 7.7 × 10⁵ |
| Example 6 | Mixed liquid 6 | SWCNT-1 | b | MWCNT-1 | b | A | 3 | 1 | 3.2 × 10⁵ |
| Example 7 | Mixed liquid 7 | SWCNT-1 | c | MWCNT-1 | c | A | 3 | 1 | 6.8 × 10⁵ |
| Example 8 | Mixed liquid 8 | SWCNT-1 | b | MWCNT-4 | b | A | 3 | 1 | 4.0 × 10⁴ |
| Example 9 | Mixed liquid 9 | SWCNT-2 | b | CB-1 | b | A | 3 | 1 | 7.3 × 10⁵ |
| Example 10 | Mixed liquid 10 | SWCNT-2 | b | CB-2 | b | A | 3 | 1 | 8.1 × 10⁵ |
| Example 11 | Mixed liquid 11 | SWCNT-2 | b | CB-3 | b | A | 3 | 1 | 8.9 × 10⁵ |
| Example 12 | Mixed liquid 12 | SWCNT-2 | b | CB-4 | b | A | 3 | 1 | 6.7 × 10⁵ |
| Example 13 | Mixed liquid 13 | SWCNT-2 | e | CB-1 | b | A | 3 | 1 | 9.9 × 10⁵ |
| Example 14 | Mixed liquid 14 | MWCNT-1 | a | CB-1 | a | A | 3 | 1 | 6.9 × 10⁴ |
| Example 15 | Mixed liquid 15 | MWCNT-1 | b | CB-1 | b | A | 3 | 1 | 5.5 × 10⁴ |
| Example 16 | Mixed liquid 16 | MWCNT-1 | b | CB-2 | b | A | 3 | 1 | 7.3 × 10⁴ |
| Example 17 | Mixed liquid 17 | MWCNT-1 | b | CB-3 | b | A | 3 | 1 | 7.0 × 10⁴ |
| Example 18 | Mixed liquid 18 | MWCNT-1 | b | CB-4 | b | A | 3 | 1 | 6.6 × 10⁴ |
| Example 19 | Mixed liquid 19 | MWCNT-2 | b | CB-1 | b | A | 3 | 1 | 7.5 × 10⁴ |
| Example 20 | Mixed liquid 20 | MWCNT-3 | b | CB-1 | b | A | 3 | 1 | 6.6 × 10⁵ |
| Example 21 | Mixed liquid 21 | MWCNT-4 | b | CB-1 | b | A | 3 | 1 | 2.1 × 10⁴ |
| Example 22 | Mixed liquid 22 | MWCNT-4 | b | CB-2 | b | A | 3 | 1 | 3.9 × 10⁴ |
| Example 23 | Mixed liquid 23 | MWCNT-4 | b | CB-3 | b | A | 3 | 1 | 3.5 × 10⁴ |
| Example 24 | Mixed liquid 24 | MWCNT-4 | b | CB-4 | b | A | 3 | 1 | 3.0 × 10⁴ |
| Example 25 | Mixed liquid 25 | SWCNT-1 | c | CB-1 | d | B | 3 | 1 | 1.9 × 10⁵ |
| Example 26 | Mixed liquid 26 | SWCNT-1 | c | CB-1 | d | B | 3 | 1 | 1.3 × 10⁵ |
| Example 27 | Mixed liquid 27 | SWCNT-1 | c | CB-1 | d | B | 3 | 1 | 8.7 × 10⁵ |
| Example 28 | Mixed liquid 26 | SWCNT-1 | c | CB-1 | d | C | 3 | 1 | 1.1 × 10⁵ |
| Example 29 | Mixed liquid 28 | MWCNT-1 | d | CB-1 | d | B | 3 | 1 | 1.0 × 10⁶ |
| Example 30 | Mixed liquid 29 | MWCNT-1 | d | CB-1 | d | B | 3 | 1 | 2.5 × 10⁵ |
| Example 31 | Mixed liquid 30 | MWCNT-1 | d | CB-1 | d | B | 3 | 1 | 1.0 × 10⁶ |
| Example 32 | Mixed liquid 29 | MWCNT-1 | d | CB-1 | d | C | 3 | 1 | 2.3 × 10⁵ |
| Example 33 | Mixed liquid 31 | SWCNT-1 | b | CB-1 | b | A | 3 | 1 | 7.8 × 10⁴ |
| Example 34 | Mixed liquid 32 | SWCNT-1 | b | CB-1 | b | A | 3 | 1 | 8.3 × 10⁴ |
| Example 35 | Mixed liquid 33 | MWCNT-1 | b | CB-1 | b | A | 3 | 1 | 9.5 × 10³ |
| Example 36 | Mixed liquid 34 | MWCNT-1 | b | CB-1 | b | A | 3 | 1 | 6.1 × 10⁴ |
| Example 37 | Mixed liquid 35 | MWCNT-1 | b | CB-1 | b | A | 3 | 1 | 2.9 × 10⁵ |
| Reference Example 1 | Mixed liquid 2 | SWCNT-1 | b | CB-1 | b | A | 3 | 5 | 1.7 × 10⁵ |
| Reference Example 2 | Mixed liquid 2 | SWCNT-1 | b | CB-1 | b | A | 3 | 10 | 7.7 × 10⁴ |
| Reference Example 3 | Mixed liquid 2 | SWCNT-1 | b | CB-1 | b | A | 5 | 1 | 4.3 × 10⁵ |
| Reference Example 4 | Mixed liquid 2 | SWCNT-1 | b | CB-1 | b | A | 5 | 10 | 1.5 × 10³ |
| Reference Example 5 | Mixed liquid 14 | MWCNT-1 | b | CB-1 | b | A | 3 | 5 | 1.1 × 10⁴ |
| Reference Example 6 | Mixed liquid 14 | MWCNT-1 | b | CB-1 | b | A | 3 | 10 | 7.1 × 10³ |
| Reference Example 7 | Mixed liquid 14 | MWCNT-1 | b | CB-1 | b | A | 5 | 1 | 3.5 × 10⁴ |
| Reference Example 8 | Mixed liquid 14 | MWCNT-1 | b | CB-1 | b | A | 5 | 10 | 8.6 × 10² |
| Comparative Example 1 | Mixed liquid 36 | SWCNT-1 | b | — | — | A | 3 | 1 | 4.9 × 10⁶ |
| Comparative Example 2 | Mixed liquid 37 | SWCNT-1 | c | CB-1 | d | A | 3 | 1 | 4.5 × 10⁶ |
| Comparative Example 3 | Mixed liquid 38 | MWCNT-1 | d | — | — | A | 3 | 1 | 5.5 × 10⁶ |
| Comparative Example 4 | Mixed liquid 39 | MWCNT-1 | d | CB-1 | d | A | 3 | 1 | 1.5 × 10⁹ |

TABLE 5

| | Viscosity | Observation | Absorbance ratio |
|---|---|---|---|
| | stability | of aggregates | (A₃₈₀/A₇₈₀) |
| Example 1 | Good | Fair | 1.829 |
| Example 2 | Excellent | Good | 1.846 |
| Example 6 | Good | Excellent | 1.855 |
| Example 14 | Good | Excellent | 1.833 |
| Example 15 | Excellent | Excellent | 1.843 |
| Example 26 | Fair | Good | 1.844 |
| Example 34 | Fair | Good | 1.821 |
| Example 35 | Excellent | Excellent | 1.804 |
| Example 36 | Good | Excellent | 1.844 |
| Example 37 | Fair | Good | 1.852 |
| Comparative Example 2 | Good | Fair | 1.549 |
| Comparative Example 4 | Good | Good | 1.540 |

### <Preparation and Evaluation (2) of Dispersion>

### (Mixed Liquids 40 to 54)

The first dispersion, second dispersion, and third dispersion of the types shown in Table 6, which are dispersions before adding a binder resin, were blended so as to give the mass ratio of carbon material 1: carbon material 2: carbon material 3 as shown in Table 6 and then mixed using a magnetic stirrer to obtain a mixed liquid. Table 7 shows the results of evaluation of viscosity stability, the results of observation of aggregates, and the absorbance ratios (A₃₈₀/A₇₈₀) for part of the obtained mixed liquids.

TABLE 6

| | | | | | | | | | | Carbon |
|---|---|---|---|---|---|---|---|---|---|---|
| | | | | | | | | | | material |
| | | | | | | | | | | 1:carbon |
| | First dispersion | | | Second dispersion | | | Third dispersion | | | material |
| | | Carbon | | | Carbon | | | Carbon | | 2:carbon |
| | | material | Disper- | | material | Disper- | | material | Disper- | material 3 |
| | Type | 1 | sant 1 | Type | 2 | sant 3 | Type | 3 | sant 3 | (mass ratio) |
| Mixed liquid 40 | Dispersion 2 | SWCNT-1 | b | Dispersion 9 | MWCNT-1 | b | Dispersion 17 | CB-1 | b | 1:30:3.44 |
| Mixed liquid 41 | Dispersion 2 | SWCNT-1 | b | Dispersion 9 | MWCNT-1 | b | Dispersion 20 | CB-2 | b | 1:30:3.44 |
| Mixed liquid 42 | Dispersion 2 | SWCNT-1 | b | Dispersion 9 | MWCNT-1 | b | Dispersion 21 | CB-3 | b | 1:30:3.44 |
| Mixed liquid 43 | Dispersion 2 | SWCNT-1 | b | Dispersion 9 | MWCNT-1 | b | Dispersion 22 | CB-4 | b | 1:30:3.44 |
| Mixed liquid 44 | Dispersion 2 | SWCNT-1 | b | Dispersion 15 | MWCNT-4 | b | Dispersion 17 | CB-1 | b | 1:30:3.44 |
| Mixed liquid 45 | Dispersion 2 | SWCNT-1 | b | Dispersion 15 | MWCNT-4 | b | Dispersion 21 | CB-3 | b | 1:30:3.44 |
| Mixed liquid 46 | Dispersion 5 | SWCNT-2 | b | Dispersion 9 | MWCNT-1 | b | Dispersion 17 | CB-1 | b | 1:30:3.44 |
| Mixed liquid 47 | Dispersion 5 | SWCNT-2 | b | Dispersion 15 | MWCNT-4 | b | Dispersion 17 | CB-1 | b | 1:30:3.44 |
| Mixed liquid 48 | Dispersion 5 | SWCNT-2 | b | Dispersion 15 | MWCNT-4 | b | Dispersion 21 | CB-3 | b | 1:30:3.44 |
| Mixed liquid 49 | Dispersion 2 | SWCNT-1 | b | Dispersion 9 | MWCNT-1 | b | Dispersion 17 | CB-1 | b | 1:10:1.22 |
| Mixed liquid 50 | Dispersion 2 | SWCNT-1 | b | Dispersion 9 | MWCNT-1 | b | Dispersion 17 | CB-1 | b | 1:100:11.2 |
| Mixed liquid 51 | Dispersion 25 | SWCNT-1 | b | Dispersion 8 | MWCNT-1 | b | Dispersion 17 | CB-1 | b | 1:30:3.44 |
| Mixed liquid 52 | Dispersion 23 | SWCNT-1 | b | Dispersion 9 | MWCNT-1 | b | Dispersion 24 | CB-1 | b | 1:30:3.44 |
| Mixed liquid 53 | Dispersion 2 | SWCNT-1 | b | Dispersion 8 | MWCNT-1 | b | Dispersion 17 | CB-1 | b | 1:1:0.22 |
| Mixed liquid 54 | Dispersion 2 | SWCNT-1 | b | Dispersion 8 | MWCNT-1 | b | Dispersion 17 | CB-1 | b | 1:30:31 |

TABLE 7

| | Viscosity | Observation | Absorbance ratio |
|---|---|---|---|
| | stability | of aggregates | (A₃₈₀/A₇₈₀) |
| Mixed liquid 40 | Excellent | Excellent | 1.721 |
| Mixed liquid 44 | Excellent | Excellent | 1.505 |
| Mixed liquid 49 | Excellent | Excellent | 1.730 |
| Mixed liquid 50 | Excellent | Excellent | 1.716 |
| Mixed liquid 51 | Good | Excellent | 1.715 |
| Mixed liquid 52 | Excellent | Excellent | 1.728 |
| Mixed liquid 53 | Good | Good | 1.734 |
| Mixed liquid 54 | Good | Excellent | 1.470 |

### Examples 38 to 50, Reference Examples 9 to 12, and Comparative Examples 5 to 6

The mixed liquid and binder of the types shown in Table 8 were blended in a ratio such that the concentration of the carbon materials in the coating film (solid content) to be formed gave a value (%) shown in Table 8 and then mixed using a magnetic stirrer to obtain a carbon material dispersion. The obtained carbon material dispersion was applied on a PET film with a thickness of 100 μm (trade name “Lumirror,” manufactured by Toray Industries, Inc.) using a bar coater and then dried in an electric oven set at 90° C. for 30 minutes to remove volatile components, and thus a coating film having a film thickness shown in Table 8 was formed. The surface resistivity of the formed coating film is shown in Table 8. Table 9 shows the results of evaluation of viscosity stability, the results of observation of aggregates, and the absorbance ratios (A₃₈₀/A₇₈₀) for part of the obtained carbon material dispersions.

TABLE 8

| | Mixed liquid | | | | | | | | Concentration | | |
|---|---|---|---|---|---|---|---|---|---|---|---|
| | | Carbon | | Carbon | | Carbon | | | (%) of carbon | Film | Surface |
| | | material | Disper- | material | Disper- | material | Disper- | | materials in | thickness | resistivity |
| | Type | 1 | sant 1 | 2 | sant 2 | 3 | sant 3 | Binder | coating film | (μm) | (Ω/sq) |
| Example 38 | Mixed liquid 40 | SWCNT-1 | b | MWCNT-1 | b | CB-1 | b | A | 3 | 1 | 4.9 × 10⁴ |
| Example 39 | Mixed liquid 41 | SWCNT-1 | b | MWCNT-1 | b | CB-2 | b | A | 3 | 1 | 6.9 × 10⁴ |
| Example 40 | Mixed liquid 42 | SWCNT-1 | b | MWCNT-1 | b | CB-3 | b | A | 3 | 1 | 6.5 × 10⁴ |
| Example 41 | Mixed liquid 43 | SWCNT-1 | b | MWCNT-1 | b | CB-4 | b | A | 3 | 1 | 6.0 × 10⁴ |
| Example 42 | Mixed liquid 44 | SWCNT-1 | b | MWCNT-4 | b | CB-1 | b | A | 3 | 1 | 8.3 × 10³ |
| Example 43 | Mixed liquid 45 | SWCNT-1 | b | MWCNT-4 | b | CB-3 | b | A | 3 | 1 | 9.7 × 10³ |
| Example 44 | Mixed liquid 46 | SWCNT-2 | b | MWCNT-1 | b | CB-1 | b | A | 3 | 1 | 4.7 × 10⁴ |
| Example 45 | Mixed liquid 47 | SWCNT-2 | b | MWCNT-4 | b | CB-1 | b | A | 3 | 1 | 8.1 × 10³ |
| Example 46 | Mixed liquid 48 | SWCNT-2 | b | MWCNT-4 | b | CB-3 | b | A | 3 | 1 | 9.4 × 10³ |
| Example 47 | Mixed liquid 49 | SWCNT-1 | b | MWCNT-1 | b | CB-1 | b | A | 3 | 1 | 5.2 × 10⁴ |
| Example 48 | Mixed liquid 50 | SWCNT-1 | b | MWCNT-1 | b | CB-1 | b | A | 3 | 1 | 5.4 × 10⁴ |
| Example 49 | Mixed liquid 51 | SWCNT-1 | b | MWCNT-1 | b | CB-1 | b | A | 3 | 1 | 7.5 × 10³ |
| Example 50 | Mixed liquid 52 | SWCNT-1 | b | MWCNT-1 | b | CB-1 | b | A | 3 | 1 | 6.0 × 10⁴ |
| Reference | Mixed liquid 44 | SWCNT-1 | b | MWCNT-4 | b | CB-1 | b | A | 3 | 5 | 1.5 × 10³ |
| Example 9 | | | | | | | | | | | |
| Reference | Mixed liquid 44 | SWCNT-1 | b | MWCNT-4 | b | CB-1 | b | A | 3 | 10 | 8.8 × 10² |
| Example 10 | | | | | | | | | | | |
| Reference | Mixed liquid 44 | SWCNT-1 | b | MWCNT-4 | b | CB-1 | b | A | 5 | 1 | 4.8 × 10³ |
| Example 11 | | | | | | | | | | | |
| Reference | Mixed liquid 44 | SWCNT-1 | b | MWCNT-4 | b | CB-1 | b | A | 5 | 10 | 4.9 × 10² |
| Example 12 | | | | | | | | | | | |
| Comparative | Mixed liquid 53 | SWCNT-1 | b | MWCNT-1 | b | CB-1 | b | A | 3 | 1 | 1.4 × 10⁶ |
| Example 5 | | | | | | | | | | | |
| Comparative | Mixed liquid 54 | SWCNT-1 | b | MWCNT-1 | b | CB-1 | b | A | 3 | 1 | 1.1 × 10⁹ |
| Example 6 | | | | | | | | | | | |

TABLE 9

| | Viscosity | Observation | Absorbance ratio |
|---|---|---|---|
| | stability | of aggregates | (A₃₈₀/A₇₈₀) |
| Example 38 | Excellent | Excellent | 1.813 |
| Example 42 | Excellent | Excellent | 1.562 |
| Example 47 | Excellent | Excellent | 1.819 |
| Example 48 | Excellent | Excellent | 1.802 |
| Example 49 | Good | Excellent | 1.799 |
| Example 50 | Excellent | Excellent | 1.820 |
| Comparative Example 5 | Good | Fair | 1.811 |
| Comparative Example 6 | Fair | Good | 1.595 |

### <Preparation and Evaluation (3) of Dispersion>

### (Mixed Liquids 55 to 58)

The dispersant of the type and amount shown in Table 10 and water of the amount shown in Table 10 were placed in a 200 mL polyethylene bottle. The resulting mixture was stirred with a magnetic stirrer until the mixture became uniform, and then the carbon material of the type and amount shown in Table 10 was added, and the resulting mixture was further stirred. Subsequently, high-pressure treatment was performed using a high-pressure homogenizer (manufactured by JOKOH CO., LTD.) under a condition of a treatment pressure of 10 about MPa. Thereafter, high-pressure dispersion treatment was performed using a high-pressure homogenizer (manufactured by SUGINO MACHINE LIMITED) under a condition of a treatment pressure of about 100 MPa to obtain a mixed liquid. Table 11 shows the results of evaluation of viscosity stability, the results of observation of aggregates, and the absorbance ratios (A₃₈₀/A₇₈₀) for the obtained mixed liquids.

TABLE 10

| | Carbon | | Carbon | | Carbon | | | | | Carbon material |
|---|---|---|---|---|---|---|---|---|---|---|
| | material 1 | | material 2 | | material 3 | | Dispersant | | Water | 1:carbon material |
| | | Amount | | Amount | | Amount | | Amount | Amount | 2:carbon material 3 |
| | Type | (parts) | Type | (parts) | Type | (parts) | Type | (parts) | (parts) | (mass ratio) |
| Mixed | SWCNT-1 | 0.40 | — | — | CB-1 | 0.04 | b | 2.44 | 97.12 | 9:0:1 |
| liquid | | | | | | | | | | |
| 55 | | | | | | | | | | |
| Mixed | — | — | MWCNT-1 | 1.00 | CB-1 | 0.10 | b | 4.10 | 94.80 | 0:9:1 |
| liquid | | | | | | | | | | |
| 56 | | | | | | | | | | |
| Mixed | SWCNT-1 | 0.03 | MWCNT-1 | 0.90 | — | — | b | 3.71 | 95.36 | 1:30:0 |
| liquid | | | | | | | | | | |
| 57 | | | | | | | | | | |
| Mixed | SWCNT-1 | 0.03 | MWCNT-1 | 0.90 | CB-1 | 0.10 | b | 4.12 | 94.85 | 1:30:3.44 |
| liquid | | | | | | | | | | |
| 58 | | | | | | | | | | |

TABLE 11

| | Viscosity | Observation | Absorbance ratio |
|---|---|---|---|
| | stability | of aggregates | (A₃₈₀/A₇₈₀) |
| Mixed liquid 55 | Good | Excellent | 1.700 |
| Mixed liquid 56 | Good | Excellent | 1.681 |
| Mixed liquid 57 | Good | Good | 1.719 |
| Mixed liquid 58 | Good | Good | 1.709 |

### Examples 51 to 54

The mixed liquid and binder of the types shown in Table 12 were blended in a ratio such that the concentration of the carbon materials in the coating film (solid content) to be formed gave a value (%) shown in Table 12 and then mixed using a magnetic stirrer to obtain a carbon material dispersion. The obtained carbon material dispersion was applied on a PET film with a thickness of 100 μm (trade name “Lumirror,” manufactured by Toray Industries, Inc.) using a bar coater and then dried in an electric oven set at 90° C. for 30 minutes to remove volatile components, and thus a coating film having a film thickness shown in Table 12 was formed. The surface resistivity of the formed coating film is shown in Table 12. Table 13 shows the results of evaluation of viscosity stability, the results of observation of aggregates, and the absorbance ratios (A₃₈₀/A₇₈₀) for the obtained carbon material dispersions.

TABLE 12

| | Mixed liquid | | | | | | | | | |
|---|---|---|---|---|---|---|---|---|---|---|
| | | | | | | Carbon material | | Concentration | Film | |
| | | Carbon | Carbon | Carbon | | 1:carbon material | | (%) of carbon | thick- | Surface |
| | | material | material | material | | 2:carbon material 3 | | materials in | ness | resistivity |
| | Type | 1 | 2 | 3 | Dispersant | (mass ratio) | Binder | coating film | (μm) | (Ω/sq) |
| Example 51 | Mixed liquid 55 | SWCNT-1 | — | CB-1 | b | 9:0:1 | A | 3 | 1 | 9.9 × 10⁵ |
| Example 52 | Mixed liquid 56 | — | MWCNT-1 | CB-1 | b | 0:9:1 | A | 3 | 1 | 1.8 × 10⁵ |
| Example 53 | Mixed liquid 57 | SWCNT-1 | MWCNT-1 | — | b | 1:30:0 | A | 3 | 1 | 5.8 × 10⁵ |
| Example 54 | Mixed liquid 58 | SWCNT-1 | MWCNT- 1 | CB-1 | b | 1:30:3.44 | A | 3 | 1 | 1.1 × 10⁵ |

TABLE 13

| | Viscosity | Observation | Absorbance ratio |
|---|---|---|---|
| | stability | of aggregates | (A₃₈₀/A₇₈₀) |
| Example 51 | Good | Good | 1.782 |
| Example 52 | Good | Excellent | 1.759 |
| Example 53 | Good | Fair | 1.798 |
| Example 54 | Good | Good | 1.792 |

### <Production (2) of Dispersant>

### (Dispersants α, β, and γ)

Dispersants α, β, and γ were produced in accordance with the above-described method for producing dispersants a and b. The characteristics of produced dispersants α, β, and γ are shown below.
Dispersant α: random copolymer, AN:AA (mass ratio)=70:30, Mn 61, 100, PDI 2.24, solid content 24.3%
Dispersant β: block copolymer
(i) chain A AN:AA (mass ratio)=80:20, Mn 45,500
(ii) chain B AN:AA (mass ratio)=48.5:51.5, Mn 16,500
(iii) whole Mn 62,000, PDI 1.44, solid content 29.7%
Dispersant γ: block copolymer
(i) chain A AN:AA (mass ratio)=80:20, Mn 21, 200
(ii) chain B AN:AA (mass ratio)=48.5:51.5, Mn 40,500
(iii) whole Mn 61, 700, PDI 1.54, solid content 29.1%

### <Preparation and Evaluation (4) of Dispersion>

### (Dispersions a-1 to 3 and B-1 to 3)

The dispersant of the type and amount shown in Table 14 and water of the amount shown in Table 14 were placed in a 200 mL polyethylene bottle. The resulting mixture was stirred with a magnetic stirrer until the mixture became uniform, and then the carbon material of the type and amount shown in Table 14 was added, and the resulting mixture was further stirred. Subsequently, high-pressure treatment was performed using a high-pressure homogenizer (manufactured by JOKOH CO., LTD.) under a condition of a treatment pressure of about 10 MPa. Thereafter, high-pressure dispersion treatment was performed using a high-pressure homogenizer (manufactured by SUGINO MACHINE LIMITED) under a condition of a treatment pressure of about 100 MPa to obtain a dispersion, which is a dispersion before adding a binder resin.

TABLE 14

| | Carbon material | | Dispersant | | Water |
|---|---|---|---|---|---|
| | | Amount | | Amount | Amount |
| | Type | (parts) | Type | (parts) | (parts) |
| Dispersion a-1 | MWCNT-1 | 1.0 | α | 4.1 | 94.9 |
| Dispersion a-2 | MWCNT-1 | 1.0 | β | 3.4 | 95.6 |
| Dispersion a-3 | MWCNT-1 | 1.0 | γ | 3.4 | 95.6 |
| Dispersion b-1 | CB-1 | 6.0 | α | 7.4 | 86.6 |
| Dispersion b-2 | CB-1 | 6.0 | β | 6.1 | 87.9 |
| Dispersion b-3 | CB-1 | 6.0 | γ | 6.2 | 87.8 |

### (Mixed Liquids α, β, and γ)

The first dispersion and second dispersion of the types shown in Table 15, which are dispersions before adding a binder resin, were blended so as to give the mass ratio of carbon material 1 to carbon material 2 as shown in Table 15 and then mixed using a magnetic stirrer to obtain a mixed liquid. Table 16 shows the results of evaluation of viscosity stability, the results of observation of aggregates, and the absorbance ratios (A₃₈₀/A₇₈₀) for the obtained mixed liquids.

TABLE 15

| | First dispersion | | | Second dispersion | | | Carbon material |
|---|---|---|---|---|---|---|---|
| | | Carbon | Dispersant | | Carbon | Dispersant | 1:carbon material 2 |
| | Type | material 1 | 1 | Type | material 2 | 2 | (mass ratio) |
| Mixed | Dispersion | MWCNT-1 | α | Dispersion | CB-1 | α | 9:1 |
| liquid | a-1 | | | b-1 | | | |
| α | | | | | | | |
| Mixed | Dispersion | MWCNT-1 | β | Dispersion | CB-1 | β | 9:1 |
| liquid | a-2 | | | b-2 | | | |
| β | | | | | | | |
| Mixed | Dispersion | MWCNT-1 | γ | Dispersion | CB-1 | γ | 9:1 |
| liquid | a-3 | | | b-3 | | | |
| γ | | | | | | | |

TABLE 16

| | Viscosity | Observation | Absorbance ratio |
|---|---|---|---|
| | stability | of aggregates | (A₃₈₀/A₇₈₀) |
| Mixed liquid α | Good | Good | 1.722 |
| Mixed liquid β | Excellent | Excellent | 1.733 |
| Mixed liquid γ | Good | Excellent | 1.727 |

### Examples 55 to 57

The mixed liquid and binder of the types shown in Table 17 were blended in a ratio such that the concentration of the carbon materials in the coating film (solid content) to be formed gave a value (%) shown in Table 17 and then mixed using a magnetic stirrer to obtain a carbon material dispersion. The obtained carbon material dispersion was applied on a PET film with a thickness of 100 μm (trade name “Lumirror,” manufactured by Toray Industries, Inc.) using a bar coater and then dried in an electric oven set at 90° C. for 30 minutes to remove volatile components, and thus a coating film having a film thickness shown in Table 17 was formed. The surface resistivity of the formed coating film is shown in Table 17. Table 18 shows the results of evaluation of viscosity stability, the results of observation of aggregates, and the absorbance ratios (A₃₈₀/A₇₈₀) for the obtained carbon material dispersions.

TABLE 17

| | Mixed liquid | | | | | | Concentration (%) | Film | Surface |
|---|---|---|---|---|---|---|---|---|---|
| | | Carbon | Dispersant | Carbon | Dispersant | | of carbon materials | thickness | resistivity |
| | Type | material 1 | 1 | material 2 | 2 | Binder | in coating film | (μm) | (Ω/sq) |
| Example 55 | Mixed liquid α | MWCNT-1 | α | CB-1 | α | A | 3 | 1 | 6.9 × 10⁴ |
| Example 56 | Mixed liquid β | MWCNT-1 | β | CB-1 | β | A | 3 | 1 | 5.1 × 10⁴ |
| Example 57 | Mixed liquid γ | MWCNT-1 | γ | CB-1 | γ | A | 3 | 1 | 5.9 × 10⁴ |

TABLE 18

| | Viscosity | Observation | Absorbance ratio |
|---|---|---|---|
| | stability | of aggregates | (A₃₈₀/A₇₈₀) |
| Example 55 | Good | Good | 1.811 |
| Example 56 | Excellent | Excellent | 1.823 |
| Example 57 | Good | Excellent | 1.816 |

### Application Example 1: Production Method in Scale-UP

In a 20 L stainless steel container, 239 parts of dispersant b, and 9,721 parts of water were placed. The resulting mixture was stirred with a dissolver until the mixture became uniform, and 40 parts of SWCNT-1 was added little by little under stirring, and then the resulting mixture was stirred for 1 hour. The mixture was sufficiently mixed by performing circulation-type treatment corresponding to 4 passes using a homogenizer (manufactured by SMT CO., LTD.). Subsequently, circulation-type, high-pressure treatment was performed using a high-pressure homogenizer (manufactured by JOKOH CO., LTD.) including a nozzle having an inner diameter of 0.44 mm under a condition of a treatment pressure of 2 to 50 MPa for a time corresponding to 10 passes. Thereafter, circulation-type, high-pressure treatment was performed using a high-pressure homogenizer (manufactured by SUGINO MACHINE LIMITED) including a nozzle having an inner diameter of 0.1 mm under a condition of a treatment pressure of 150 MPa for a time corresponding to 5 passes. A dispersion, which is a dispersion before adding a binder resin, was prepared in the same manner using 398 parts of dispersant b, 100 parts of MWCNT-1, and water in an amount adjusted such that the total amount of dispersant b, MWCNT-1, and water was 10,000 parts. Furthermore, a dispersion, which is a dispersion before adding a binder resin, was prepared in the same manner using 717 parts of dispersant b, 600 parts of CB-1, and water in an amount adjusted such that the total amount of dispersant b, CB-1, and water was 10,000 parts. The solutions were mixed under stirring with a dissolver such that the ratio of the carbon materials satisfied SWCNT-1:MWCNT-1:CB-1=1:30:3.34, and thus a mixed dispersion, which is a dispersion before adding a binder resin, was obtained. Both of the result of evaluation of viscosity stability and the result of observation of aggregates were “Excellent” for the resulting mixed dispersion. Binder A in an amount that made the concentration of the carbon materials in the total solid content 3% was added to the resulting mixed dispersion under stirring with a dissolver. Both of the result of evaluation of viscosity stability and the result of observation of aggregates were “Excellent” for the carbon material dispersion after adding the binder resin. Thereafter, the carbon material dispersion was applied on a PET film with a thickness of 100 μm (trade name “Lumirror,” manufactured by Toray Industries, Inc.) using a bar coater and then dried in an electric oven set at 90° C. for 30 minutes to remove volatile components, and thus a coating film was formed. The concentration of the carbon materials in the coating film was 3%, the film thickness of the coating film was 1 μm, and the surface resistivity of the coating film was 5.2×10⁴ Ω/sq.

In Application Example 1, the dispersions for respective carbon materials, which are dispersions before adding a binder resin, were prepared, and the prepared dispersions were mixed to obtain a carbon material dispersion containing a plurality of carbon materials each in a predetermined ratio. Note that all the carbon materials may be charged at the first stage to perform dispersion treatment. In addition, the carbon materials and the dispersants may be charged halfway through the dispersion treatment. For example, SWCNT and a dispersant may be charged into a dispersion containing MWCNT and a dispersant to perform dispersion treatment, and then CB and a dispersant may be charged into the resulting dispersion to perform dispersion treatment.

### Application Example 2-1: Battery Material (Negative Electrode)

The following materials were used in producing a negative electrode of a lithium-ion battery.

### [Negative Electrode Active Material]

Graphene (manufactured by FUJIFILM Wako Pure Chemical Corporation).
Silicon monoxide (manufactured by FUJIFILM Wako Pure Chemical Corporation)

### [Binder]

10% Aqueous polyacrylic acid solution (trade name “CLPA-C07,” manufactured by FUJIFILM Wako Pure Chemical Corporation).
Carboxymethyl cellulose (trade name “CMC Daicel 2200,” manufactured by Daicel Miraizu Ltd.)
Styrene/butadiene copolymer latex (trade name “SR-112,” manufactured by NIPPON A&L INC.)

A negative electrode material was obtained by mixing 15 parts of silicon monoxide, 85 parts of graphene, 3 parts of mixed liquid 40, 30 parts of the 10% aqueous polyacrylic acid solution, 1.6 parts of carboxymethyl cellulose, and 0.4 parts of the styrene/butadiene copolymer latex using a planetary mixer. The negative electrode material was applied on a copper foil with a thickness of 20 μm using an applicator such that the weight per unit area after drying was 15 mg/cm². Note that another mixing apparatus, such as a rotating/revolving mixer, may be used for mixing. The applied negative electrode material was placed in an oven set at 120° C. for 30 minutes for drying, and then the copper foil was rolled with a roll press to obtain a negative electrode. The obtained negative electrode had a volume resistivity of 0.14 Ω·cm and a capacity retention of 95%.

### Application Example 2-2: Battery Material (Negative Electrode)

A negative electrode was produced in the same manner as in Application Example 2-1 except that mixed liquid 38 was used in place of mixed liquid 40. The produced negative electrode had a volume resistivity of 0.39 Ω·cm and a capacity retention of 93%. It was found from those described above that the use of a mixed liquid for which evaluation of dispersion is good makes it possible to produce a negative electrode exhibiting a smaller volume resistivity value.

### Application Example 3-1: Antistatic Coating Agent

In a plastic cup, 100 g of mixed liquid 40, 100 g of a polymer binder (trade name “NeoPac R-9699,” manufactured by Kusumoto Chemicals, Ltd., acrylic urethane resin, solid content 40%), and 800 of pure water were placed, and the resulting mixture was stirred with a dissolver to obtain an antistatic coating agent. The obtained antistatic coating agent was applied on a surface of a polyethylene terephthalate film with a thickness of 38 μm (manufactured by Toray Corporation) using a bar coater such that the coating film after drying had a thickness of 0.5 μm. The applied antistatic coating agent was placed in an oven set at 80° C. for 10 minutes for drying to obtain an antistatic coating film. The obtained film had a surface resistivity of 9.8×10⁵ Ω/cm².

### Application Example 3-2: Antistatic Coating Agent

An antistatic coating film was produced in the same manner as in Application Example 3-1 except that mixed liquid 38 was used in place of mixed liquid 40. The produced film had a surface resistivity of 5.7×10⁷ Ω/cm². It was found from those described above that the use of a mixed liquid for which evaluation of dispersion is good makes it possible to produce an antistatic coating film exhibiting a smaller surface resistivity value.

### INDUSTRIAL APPLICABILITY

The carbon material dispersion of the present invention is not only useful as a constituent material for paints, inks, resin shaped articles, and the like which exhibit characteristics such as high electrical conductivity and high thermal conductivity but also suitable for various applications such as battery materials, electronic component trays, IC chip covers, electromagnetic wave shields, automobile members, and robot components.

1. A carbon material dispersion comprising:
at least two carbon materials selected from the group consisting of single-walled carbon nanotubes, multi-walled carbon nanotubes, and carbon black;
an aqueous medium;
a dispersant; and
a binder resin, wherein
the carbon material dispersion satisfies the following requirements (1) and (2),
surface resistivity a (Ω/sq) of a first film formed by applying and drying the carbon material dispersion, the first film containing 3% by mass of the carbon materials and having a thickness of 1 μm and surface resistivity b (Ω/sq) of a second film formed by applying and drying a control dispersion having the same composition as the carbon material dispersion except that one of the carbon materials is not contained, the second film containing 3% by mass of the carbon material or carbon materials and having a thickness of 1 μm satisfy a relationship of a<b, and
the surface resistivity a is 5.0×105 Ω/sq or less:
(1) when the carbon materials are composed of a combination of a single-walled carbon nanotube and carbon black, the amount of carbon black based on 1 part by mass of the single-walled carbon nanotube is 0.001 to 0.43 parts by mass,
when the carbon materials are composed of a combination of a multi-walled carbon nanotube and carbon black, the amount of carbon black based on 1 part by mass of the multi-walled carbon nanotube is 0.001 to 0.43 parts by mass,
when the carbon materials are composed of a combination of a single-walled carbon nanotube and a multi-walled carbon nanotube, the amount of the multi-walled carbon nanotube based on 1 part by mass of the single-walled carbon nanotube is 10 to 100 parts by mass, or
when the carbon materials are composed of a combination of a single-walled carbon nanotube, a multi-walled carbon nanotube, and carbon black, the amount of carbon black based on 1 part by mass of the total amount of the single-walled carbon nanotube and the multi-walled carbon nanotube is 0.001 to 0.43 parts by mass, and the amount of the multi-walled carbon nanotube based on 1 part by mass of the single-walled carbon nanotube is 10 to 100 parts by mass;
(2) the surface resistivity of the dry film containing 3% by mass of the carbon materials and having a thickness of 1 μm is 1.0×10⁶ Ω/sq or less.

2. The carbon material dispersion according to claim 1, wherein
the dispersant is at least any one of a polymeric dispersant and a cellulose derivative, and
the polymeric dispersant is a polymer having a constituent unit (1) derived from (meth)acrylonitrile and a constituent unit (2) derived from (meth)acrylic acid.

3. The carbon material dispersion according to claim 2, wherein the polymeric dispersant is a polymer having carboxy groups at least part of which are neutralized with an alkali, the polymer having 50 to 80% by mass of the constituent unit (1) and 20 to 50% by mass of the constituent unit (2), provided that the total amount of the constituent unit (1) and the constituent unit (2) is 100% by mass.

4. The carbon material dispersion according to claim 3, wherein
the polymer is an A-B block copolymer comprising:
a polymer block A having 60 to 95% by mass of a constituent unit (1-A) derived from acrylonitrile and 5 to 40% by mass of a constituent unit (2-A) derived from methacrylic acid, provided that the total amount of the constituent unit (1-A) and the constituent unit (2-A) is 100% by mass; and
a polymer block B having 10 to 70% by mass of a constituent unit (1-B) derived from acrylonitrile and 30 to 90% by mass of a constituent unit (2-B) derived from methacrylic acid, provided that the total amount of the constituent unit (1-B) and the constituent unit (2-B) is 100% by mass,
the polymer block A has a number average molecular weight of 10,000 to 100,000 and a polydispersity index of 1.8 or less, and
the polymer block B has a number average molecular weight of 3,000 to 200,000.

5. The carbon material dispersion according to claim 1, wherein the binder resin is at least one selected from the group consisting of cellulose derivatives, styrene-butadiene copolymers, and acrylic resins.

6. The carbon material dispersion according to claim 1, wherein
when the carbon materials comprise a single-walled carbon nanotube, the amount of the dispersant based on 100 parts by mass of the single-walled carbon nanotube is 30 to 200 parts by mass,
when the carbon materials comprise a multi-walled carbon nanotube, the amount of the dispersant based on 100 parts by mass of the multi-walled carbon nanotube is 30 to 200 parts by mass, and
when the carbon materials comprise carbon black, the amount of the dispersant based on 100 parts by mass of carbon black is 10 to 200 parts by mass.

7. The carbon material dispersion according to claim 1, wherein
the single-walled carbon nanotubes have an average length of 5 to 600 μm, and
the multi-walled carbon nanotubes have an average length of 40 to 3,000 μm.

8. The carbon material dispersion according to claim 1, obtained by mixing
a first dispersion comprising at least one of the carbon materials and
a second dispersion comprising at least one of the carbon materials, different from the carbon material in the first dispersion.

9. The carbon material dispersion according to claim 1, wherein when a dilute dispersion is obtained by diluting the carbon material dispersion with a blank solution having the same composition as the carbon material dispersion except that the carbon materials are not contained in such a way that absorbance at a wavelength of 580 nm is 1.8±0.02, a ratio (A_{L}/A_{H}) of absorbance A_{L} at a wavelength of 380 nm to absorbance A_{H} at a wavelength of 780 nm is 1.40 or more for the dilute dispersion.

10. Use of the carbon material dispersion according to claim 1 for producing any one of the products of paints, inks, coating agents, materials for resin shaped articles, electrically conductive materials, thermally conductive materials, and antistatic agents.

11. Use of the carbon material dispersion according to claim 1 for producing any one of the products of battery materials and mechanical components each comprising a film formed with the carbon material dispersion.
